(19) United States
(12) Patent Application Publication
(10) Pub. No.: US 2026/0101186 A1
(43) Pub. Date: Apr. 9, 2026

(54) METHOD AND DEVICE FOR AUTHORIZING APPLICATION FUNCTION

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/113,991

(22) PCT Filed: Sep. 30, 2022
(86) PCT No.: PCT/CN2022/123345

§ 371 Date: Mar. 21, 2025

(51) Int. Cl. H04W 12/062; H04W 12/08

(52) U.S. Cl. CPC H04W 12/062; H04W 12/08

(57) ABSTRACT

A method for authorizing an application function, performed by a first network device, includes: receiving a first request sent by a second network device, the first request being used to request to authorize the second network device to configure a personal IoT network (PIN); obtaining an authorization profile updated by a terminal; and determining whether to authorize the first request based on the authorization profile.

### CROSS-REFERENCE TO RELATED APPLICATIONS

This application is the US national phase application of International Application No. PCT/CN2022/123345 filed on Sep. 30, 2022, the entire contents of which are incorporated herein by reference.

### FIELD

The present disclosure relates to the technical field of communication technologies, and more particularly to a method and a device for authorizing an application function.

### BACKGROUND

A personal Internet of things (IoT) network (PIN) may be configured by the application function (AF) through the network exposure function (NEF) of 5G, such as the quality of service (QOS) of the PIN element, the connection information related to the PIN element, the user equipment (UE) route selection policy (URSP) rules related to the PIN element, etc.

From a security perspective, the access range of the AF should be limited, and such access requires authorization and permission.

### SUMMARY

In a first aspect, an embodiment of the present disclosure provides a method for authorizing an application function, performed by a first network device, and including:
receiving a first request sent by a second network device, in which the first request is used to request to authorize the second network device to configure a personal IoT network (PIN);
obtaining an authorization profile updated by a terminal; and
determining whether to authorize the first request based on the authorization profile.

In a second aspect, an embodiment of the present disclosure provides a method for authorizing an application function, performed by a second network device, and including:
sending a first request to a first network device, in which the first request is used to request the first network device to authorize the second network device to configure a PIN based on an authorization profile updated by a terminal.

In a third aspect, an embodiment of the present disclosure provides a method for authorizing an application function, performed by a terminal, and including:
updating an authorization profile of the terminal, in which the authorization profile is used by a first network device to determine whether to authorize a first request from a second network device, and the first request is used to request to authorize the second network device to configure a PIN.

In a fourth aspect, an embodiment of the present disclosure provides a first network device, including:
a processor; and
a memory for storing a computer program executable by the processor;
in which the processor is configured to perform the method of the first aspect above.

In a fifth aspect, an embodiment of the present disclosure provides a second network device, including:
a processor; and
a memory for storing a computer program executable by the processor;
in which the processor is configured to perform the method of the second aspect above.

Additional aspects and advantages of the present disclosure will be given in part in the below description below, and will become apparent from the description below, or will be known through the practice of the present disclosure.

### BRIEF DESCRIPTION OF THE DRAWINGS

In order to more clearly illustrate the technical solutions in the embodiments of the present disclosure or the background, the drawings required for use in the embodiments of the present disclosure or the background will be described below.

FIG. 1 is an architecture diagram of a communication system provided by an embodiment of the present disclosure;

FIG. 2 is a flow chart of a method for authorizing an application function provided by an embodiment of the present disclosure;

FIG. 3 is a flow chart of a method for authorizing an application function provided by an embodiment of the present disclosure;

FIG. 4 is a flow chart of a method for authorizing an application function provided by an embodiment of the present disclosure;

FIG. 5 is a flow chart of a method for authorizing an application function provided by an embodiment of the present disclosure;

FIG. 6 is a flow chart of a method for authorizing an application function provided by an embodiment of the present disclosure;

FIG. 7 is a flow chart of a method for authorizing an application function provided by an embodiment of the present disclosure;

FIG. 8 is a flow chart of a method for authorizing an application function provided by an embodiment of the present disclosure;

FIG. 9 a flow chart of a method for authorizing an application function provided by an embodiment of the present disclosure;

FIG. 10 a flow chart of a method for authorizing an application function provided by an embodiment of the present disclosure;

FIG. 11 a flow chart of a method for authorizing an application function provided by an embodiment of the present disclosure;

FIG. 12 a flow chart of a method for authorizing an application function provided by an embodiment of the present disclosure;

FIG. 13 a flow chart of a method for authorizing an application function provided by an embodiment of the present disclosure;

FIG. 14 is a schematic diagram of a flow chart of a method for obtaining a control plane authorization profile according to an embodiment of the present disclosure;

FIG. 15 is a schematic diagram of a flow chart of a method for obtaining a user plane authorization profile according to an embodiment of the present disclosure;

FIG. 16a is a flow chart of a method for authorizing an application function provided in an embodiment of the present disclosure;

FIG. 16b is a flow chart of a method for authorizing an application function provided in an embodiment of the present disclosure;

FIG. 16c is a flow chart of a method for authorizing an application function provided in an embodiment of the present disclosure;

FIG. 16d is a flow chart of a method for authorizing an application function provided in an embodiment of the present disclosure;

FIG. 17 is a schematic diagram of the structure of a device for authorizing an application function provided in an embodiment of the present disclosure;

FIG. 18 is a schematic diagram of the structure of a device for authorizing an application function provided in an embodiment of the present disclosure;

FIG. 19 is a schematic diagram of the structure of a device for authorizing an application function provided in an embodiment of the present disclosure;

FIG. 20 is a schematic diagram of a communication system provided in an embodiment of the present disclosure;

FIG. 21 is another schematic diagram of the structure of a device for authorizing an application function provided in an embodiment of the present disclosure;

FIG. 22 is a schematic diagram of the structure of a chip provided in an embodiment of the present disclosure.

### DETAILED DESCRIPTION

Embodiments will be described in detail herein, examples of which are shown in the accompanying drawings. When the following description refers to the drawings, unless otherwise indicated, the same reference numbers in different drawings represent the same or similar elements. The implementation described in the following embodiments do not represent all embodiments consistent with the embodiments of the present disclosure. Instead, they are merely examples of devices and methods consistent with some aspects of the embodiments of the present disclosure as detailed in the appended claims.

The terms used in the embodiments of the present disclosure are only for the purpose of describing specific embodiments, and are not intended to limit the embodiments of the present disclosure. The singular forms of “a” and “the” used in the embodiments of the present disclosure and the appended claims are also intended to include plural forms, unless the context clearly indicates other meanings. It should also be understood that the term “and/or” used herein refers to and includes any or all possible combinations of one or more associated listed items.

It should be understood that, although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” as used herein may be interpreted as “at the time that . . . ” or “when . . . ” or “in response to . . . ”.

The embodiments of the present disclosure are described in detail below, and examples of the embodiments are shown in the accompanying drawings, the same or similar reference numerals throughout the description represent the same or similar elements. The embodiments described below with reference to the accompanying drawings are exemplary and are intended to be used to explain the present disclosure, and should not be construed as limiting the present disclosure.

In order to better understand a method for authorizing an application function disclosed in an embodiment of the present disclosure, the communication system to which an embodiment of the present disclosure is applicable is first described below.

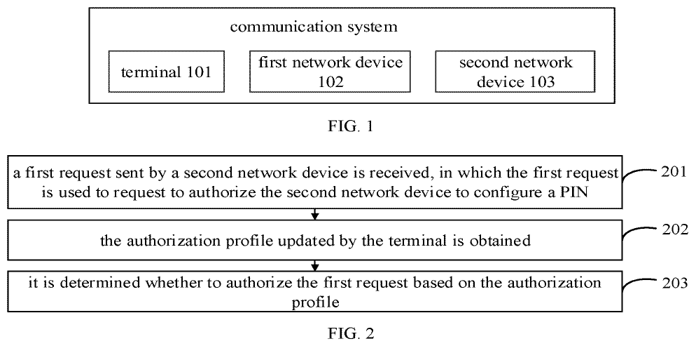

FIG. 1 is a schematic diagram of the architecture of a communication system provided in an embodiment of the present disclosure. The communication system may include but is not limited to a terminal and a core network device. The number and form of devices shown in FIG. 1 are only used for example and do not constitute a limitation on an embodiment of the present disclosure. In actual applications, two or more network devices and two or more terminals may be included. The communication system shown in FIG. 1 includes a terminal 101, a first network device 102 and a second network device 103 as an example.

It should be noted that the technical solutions of the embodiments of the present disclosure may be applied to various communication systems, such as Long Term Evolution (LTE) system, fifth generation (5G) mobile communication system, 5G new air interface system, or other future new mobile communication systems.

The terminal 101 in an embodiment of the present disclosure is an entity on the user side for receiving or transmitting signals, such as a mobile phone. The terminal may also be referred to as a terminal, a user equipment (UE), a mobile station (MS), a mobile terminal (MT), etc. The terminal may be a car with communication function, a smart car, a mobile phone, a wearable device, a tablet computer (Pad), a computer with wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. An embodiment of the present disclosure does not limit the specific technology and specific device form adopted by the terminal.

In an embodiment of the present disclosure, the first network device 102 and the second network device 103 are both entities on the network side that may independently complete certain transmission functions. The first network device 102 and the second network device 103 may be network element functions deployed in the core network, or they may be application functions (AF) deployed by operators. For example, Policy Control Function (PCF), Network Exposure Function (NEF), Unified Data Repository (UDR), Network Repository Function (NRF), Common application programming interface (API) Framework core function (CAPIF), etc. An embodiment of the present disclosure does not limit the specific technology and specific device form adopted by the network device.

In related discussions, certain aspects of the PIN may be configured by the application function (AF) through the 5G NEF, such as the QoS of the PIN element, the connection information related to the PIN element, the URSP rules related to the PIN element, etc.

The AF may configure and manage the PIN. Furthermore, the AF may configure parameters for the elements in the PIN.

From a security perspective, the scope of the access of AF should be limited, and the access needs to be authorized and agreed. In the related art, there is no technical solution to limit AF to a level of certain specific PIN and resource owner.

It should be noted that the PIN includes at least one PIN element (PINE). Among them, some PIN elements have management capabilities, and PIN elements with management capabilities (PEMC) may manage the PIN to which the PIN element belongs; some PIN elements have gateway capabilities, and PIN elements with gateway capabilities (PEGC) may serve as the gateway of the PIN to which it belongs; some PIN elements have neither management capabilities nor gateway capabilities, and are regular PIN elements (regular PINE), and each regular PINE has a PEGC associated with the regular PINE. AF needs to configure the parameters for the regular PINE through the PEGC associated with the regular PINE.

It may be understood that in each embodiment of the present disclosure, the information interaction between the terminal and each core network device is completed through the transparent transmission of the access network device.

It may be understood that the communication system described in an embodiment of the present disclosure is for more clearly illustrating the technical solution of an embodiment of the present disclosure, and does not constitute a limitation on the technical solution provided in an embodiment of the present disclosure. Ordinary skilled in the art may know that with the evolution of the system architecture and the emergence of new business scenarios, the technical solution provided in an embodiment of the present disclosure is also applicable to solve similar technical problems.

The method and device for authorizing an application function provided by the present disclosure are described in detail below with reference to the accompanying drawings.

FIG. 2 is a flow chart of a method for authorizing an application function provided in an embodiment of the present disclosure. It should be noted that the method for authorizing an application function in an embodiment of the present disclosure is performed by the first network device. The method may be performed independently or in combination with any other embodiment of the present disclosure. As shown in FIG. 2, the method may include the following steps.

Step 201, a first request sent by a second network device is received, in which the first request is used to request to authorize the second network device to configure a PIN.

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN; an identifier of a PEMC in the target PIN; an identifier of a target PIN element, or a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

It may be understood that the target PINE may be the terminal or a regular PINE associated with the terminal.

In an embodiment of the present disclosure, the first network device is at least one of: PCF, NEF, UDR, CAPIF core function, or NRF. The second network device is an application function AF, which may be deployed by an operator and may be an intranet AF (trusted) or an extranet AF (untrusted).

In some implementations, the first network device may obtain an authorization profile based on the first request.

Step 202, the authorization profile updated by the terminal is obtained.

In an embodiment of the present disclosure, the first network device may obtain the authorization profile updated by the terminal, and determine whether to authorize the first request of the second network device based on the information in the authorization profile.

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In some implementations, if the terminal is a PEGC, the profile updated by the terminal includes: an identifier of the terminal, and an identifier of the second network device allowed to configure a parameter for the terminal.

If the terminal is a PEMC, the profile updated by the terminal includes: an identifier of the terminal, an identifier of the second network device allowed to configure a parameter for the terminal, information of a PIN managed by the terminal, and an identifier of the second network device allowed to configure the PIN managed by the terminal.

The information of the PIN managed by the terminal includes at least one of: an identifier of the PIN managed by the terminal; an identifier of the PEGC in the PIN managed by the terminal; an identifier of the PEMC in the PIN managed by the terminal; an identifier of a regular PINE in the PIN managed by the terminal; and an association relationship between the regular PINE and the PEGC in the PIN managed by the terminal.

In some embodiments, the profile updated by the terminal includes: an identifier of the terminal, an identifier of the second network device allowed to configure a parameter for the terminal, information of a PIN to which the terminal belongs, and an identifier of the second network device allowed to configure the PIN to which the terminal belongs.

The information of the PIN to which the terminal belongs includes at least one of the following: an identifier of the PIN to which the terminal belongs; an identifier of the PEGC in the PIN to which the terminal belongs; an identifier of the PEMC in the PIN to which the terminal belongs; an identifier of a regular PINE in the PIN to which the terminal belongs; and an association relationship between the regular PINE and PEGC in the PIN to which the terminal belongs.

In an embodiment of the present disclosure, as an example, the identifier of the terminal may be a subscription permanent identifier (SUPI), a subscription concealed identifier (SUCI), a generic public subscription identifier (GPSI), an IP multimedia private identity (IMPI (IMS, IP Multimedia Subsystem)), and the like.

In some implementations, the first network device may obtain the authorization profile updated by the PEMC based on the identifier of the PEMC in the target PIN in the first request, and determine whether to authorize the first request based on the authorization profile.

In some implementations, on a control plane, the first network device may subscribe to a notification from a unified data management (UDM) regarding an update of the authorization profile. The first network device may also cancel the subscription. In response to updating the authorization profile by the terminal, the first network device may receive a notification sent by the UDM, and the notification may include the authorization profile updated by the terminal.

In some implementations, on a user plane, the first network device may send a second request to a third network device, the second request is used to request an authorization profile updated by the terminal. The second request includes an identifier of the terminal (that is, an identifier of the PEMC in the target PIN in the first request), and the first network device may receive the authorization profile updated by the terminal and sent by the third network device.

The third network device may store the authorization profile generated or updated by each terminal and the identifier of the terminal corresponding to each authorization profile. The third network device may also be an application function deployed by the operator, for example, the third network device may be an authorization profile management function (APMF).

Step 203, it is determined whether to authorize the first request based on the authorization profile.

In an embodiment of the present disclosure, the first network device may determine whether to authorize the first request sent by the second network device based on the obtained authorization profile, and determine whether to authorize the second network device to configure the target PIN and/or configure the parameter for the target PINE.

In some implementations, the first network device may confirm whether the second network device is allowed to configure the target PIN based on the authorization profile.

In some implementations, the first network device may confirm whether the target PINE requested by the second network device belongs to the target PIN based on the authorization profile.

In some implementations, the first network device may confirm whether the second network device is allowed to configure the parameter for the target PINE based on the authorization profile.

In embodiments of the present disclosure, after authorizing the second network device to configure the target PIN, the second network device may provide the PCF or UDR with a parameter for configuring the target PIN (such as the first parameter in the first request).

In summary, by receiving the first request sent by the second network device, in which the first request is used to request to authorize the second network device to configure a PIN, the authorization profile updated by the terminal is obtained, and whether to authorize the first request is determined based on the authorization profile, so that the first network device may verify whether the access of the second network device is allowed based on the authorization of the resource owner, that is, the terminal, and the access of the second network device may be limited to a level of a specific network and resource owner, thereby effectively ensuring the privacy and security of the PIN, while ensuring the security of the communication system.

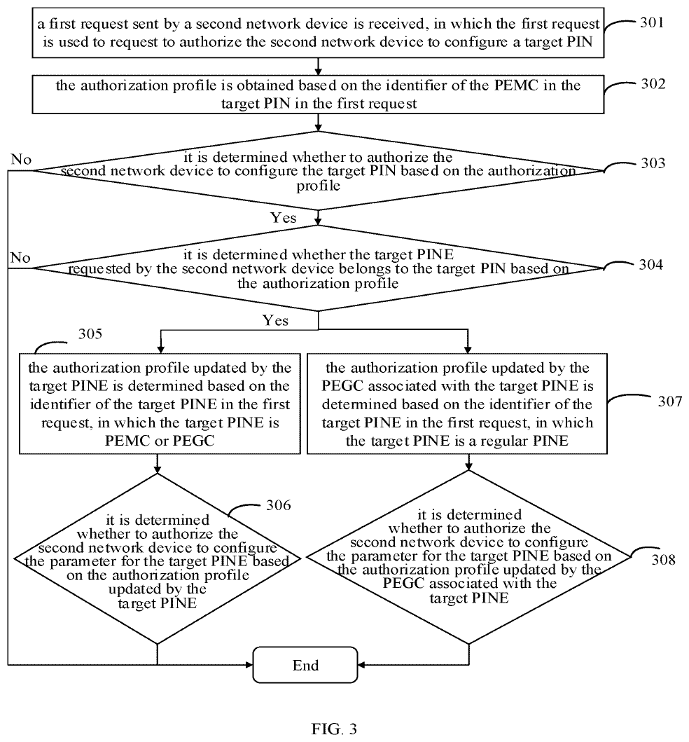

FIG. 3 is a flow chart of a method for authorizing an application function provided in an embodiment of the present disclosure. It should be noted that the method for authorizing an application function in an embodiment of the present disclosure is executed by the first network device. The method may be executed independently or in combination with any other embodiment of the present disclosure. As shown in FIG. 3, the method may include the following steps.

Step 301, a first request sent by a second network device is received, in which the first request is used to request to authorize the second network device to configure a target PIN.

In an embodiment of the present disclosure, the first network device is capable of receiving a first request sent by the second network device, and the second network device requests the first network device to authorize the second network device to configure a PIN.

The first request may include at least one of the following:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device is at least one of: PCF, NEF, UDR, CAPIF core function, or NRF. The second network device is an application function AF, which may be deployed by an operator and may be an intranet AF (trusted) or an extranet AF (untrusted).

In an embodiment of the present disclosure, the first network device may obtain the authorization profile based on the first request.

Step 302, the authorization profile is obtained based on the identifier of the PEMC in the target PIN in the first request.

In an embodiment of the present disclosure, the first network device may obtain the authorization profile corresponding to the PEMC based on the identifier of the PEMC in the target PIN in the first request, and determine whether to authorize the first request of the second network device based on the information in the authorization profile.

In an embodiment of the present disclosure, the authorization profile is generated and updated by the terminal, and may be used to verify whether the second network device may configure and manage a specific PIN.

In embodiments of the present disclosure, the terminal is a PIN element with a management capability (PEMC), or a PIN element with a gateway capability (PEGC).

It should be noted that in the PIN, PEMC (or PEGC) may generate and update the authorization profile corresponding to the PEMC (or PEGC), while the regular PINE cannot generate and update the authorization profile.

In an embodiment of the present disclosure, the profile updated by the PEGC includes: an identifier of the PEGC, and an identifier of the second network device allowed to configure a parameter for the PEGC (such as AF ID, application layer ID, etc.).

The profile updated by PEMC includes: the identifier of the PEMC, the identifier of the second network device allowed to configure the parameter for the PEMC (such as AF ID, application layer ID, etc.), the information of the PIN managed by the PEMC, and an identifier of the second network device allowed to configure the PIN managed by the PEMC (such as AF ID, application layer ID, etc.).

The information of the PIN managed by the PEMC includes at least one of: an identifier of the PIN managed by the PEMC; an identifier of the PEGC in the PIN managed by the PEMC; an identifier of the PEMC in the PIN managed by the PEMC; an identifier of the regular PINE in the PIN managed by the PEMC; the association relationship between the regular PINE and PEGC in the PIN managed by the PEMC.

In some implementations, on a control plane, the first network device may subscribe to a notification from a unified data management (UDM) regarding an update of the authorization profile. The first network device may also cancel the subscription. In response to updating the authorization profile by the terminal, the first network device may receive a notification sent by the UDM, and the notification may include the authorization profile updated by the terminal.

In some implementations, on a user plane, the first network device may send a second request to a third network device, the second request is used to request an authorization profile updated by the terminal. The second request includes an identifier of the terminal (that is, an identifier of the PEMC in the target PIN in the first request), and the first network device may receive the authorization profile updated by the terminal and sent by the third network device.

The third network device may store the authorization profile generated or updated by each terminal and the identifier of the terminal corresponding to each authorization profile. The third network device may also be an application function deployed by the operator, for example, the third network device may be an authorization profile management function (APMF).

Step 303, it is determined whether to authorize the second network device to configure the target PIN based on the authorization profile.

In an embodiment of the present disclosure, after the first network device obtains the authorization profile based on the identifier of the PEMC in the target PIN in the first request, the first network device may obtain an identifier of the second network device allowed to configure the target PIN in the authorization profile, and determine whether a third identifiers of the second network device sending the first request is within a permitted range, and then determine whether to authorize the second network device to configure the target PIN.

It may be understood that if the third identifier of the second network device sending the first request is not within the permitted range, the first request is rejected and the authorization process is terminated.

In an implementation, the first request further includes an identifier of the target PINE, that is, the second network device further requests to configure the parameter for the target PINE. The method may further include the following steps.

Step 304, it is determined whether the target PINE requested by the second network device belongs to the target PIN based on the authorization profile.

In an embodiment of the present disclosure, the second network device requests to configure the parameter for the target PINE (such as QoS, connection information related to the target PINE, URSP rules related to the target PINE, etc.), and the first network device may determine whether the target PINE belongs to the target PIN based on the target PIN information in the authorization profile.

The target PIN information in the authorization profile may include at least one of: an identifier of the target PIN, an identifier of the PEGC in the target PIN, an identifier of the PEMC in the target PIN, an identifier of a regular PINE in the target PIN, and an association relationship between the regular PINE and the PEGC in the target PIN. Therefore, the first network device may determine whether the target PINE belongs to the target PIN based on the authorization profile.

It is understandable that if it is determined that the target PINE does not belong to the target PIN, the first request is rejected and the authorization process is terminated.

Step 305, the authorization profile updated by the target PINE is determined based on the identifier of the target PINE in the first request, in which the target PINE is PEMC or PEGC.

In an embodiment of the present disclosure, the second network device requests to configure a parameter for a target PINE, the target PINE is PEMC or PEGC, and the first network device may directly determine the authorization profile updated by the target PINE based on the identifier of the target PINE.

The authorization profile updated by the target PINE includes an identifier of the second network device allowed to configure a parameter for the target PINE.

Step 306, it is determined whether to authorize the second network device to configure the parameter for the target PINE based on the authorization profile updated by the target PINE.

In an embodiment of the present disclosure, the first network device may determine whether a fourth identifier of the second network device sending the first request is within a permitted range based on the identifier of the second network device allowed to configure the parameter for the target PINE included in the authorization profile updated by the target PINE.

It may be understood that if the fourth identifier of the second network device sending the first request is within the permitted range, the second network device is authorized to configure the parameter for the target PINE, the first request is authorized, and the authorization process is completed; if the fourth identifier of the second network device sending the first request is not within the permitted range, the first request is rejected and the authorization process is terminated.

Step 307, the authorization profile updated by the PEGC associated with the target PINE is determined based on the identifier of the target PINE in the first request, in which the target PINE is a regular PINE.

In an embodiment of the present disclosure, the second network device requests to configure a parameter for a target PINE which is a regular PINE, so the identifier of the target PINE includes: the PINE ID of the regular PINE, and an identifier of the PEGC associated with the target PINE. The first network device needs to determine the authorization profile updated by the PEGC associated with the target PINE based on the identifier of the PEGC associated with the target PINE in the identifier of the target PINE.

The authorization profile updated by the PEGC associated with the target PINE includes an identifier of the second network device allowed to configure a parameter for PEGC associated with the target PINE.

It should be noted that the second network device needs to configure the parameter for the regular PINE through the PEGC associated with the regular PINE. Therefore, the second network device allowed to configure the parameter for the PEGC is also allowed to configure the parameter for the regular PINE.

Step 308, it is determined whether to authorize the second network device to configure the parameter for the target PINE based on the authorization profile updated by the PEGC associated with the target PINE.

In an embodiment of the present disclosure, the first network device may determine whether the fifth identifier of the second network device sending the first request is within the permitted range based on the identifier of the second network device allowed to configure the parameter for the PEGC associated with the target PINE, which is included in the authorization profile updated by the PEGC associated with the target PINE.

It may be understood that if the fifth identifier of the second network device sending the first request is within the permitted range, the second network device is authorized to configure the parameter for the target PINE, the first request is authorized, and the authorization process is completed; if the fifth identifier of the second network device sending the first request is not within the permitted range, the first request is rejected and the authorization process is terminated.

It should be noted that, in an embodiment of the present disclosure, the aforementioned steps 303 to 308 are the first network device verifying the first request based on the obtained authorization profile to confirm whether to authorize the first request. Execution of some or all of the aforementioned steps 303 to 308 are within the protection scope of the present disclosure. Moreover, the execution order of steps 303 to 308 is not limited in this embodiment. In the process of executing the above steps, as long as the first network device rejects the request in a certain verification step, the authorization process is directly terminated and the subsequent verification steps are no longer executed. As long as the first network device passes the authorization in each verification step, the authorization of the first request may be finally confirmed. Any execution order and combination of any one or more of the above steps are within the protection scope of the present disclosure.

In summary, by receiving the first request sent by the second network device, in which the first request is used to request to authorize the second network device to configure the target PIN, an authorization profile is obtained based on the identifier of the PEMC in the target PIN in the first request, and it is determined whether the second network device is authorized to configure the target PIN based on the authorization profile, and it is determined whether the target PINE requested by the second network device belongs to the target PIN based on the authorization profile, and it is determined whether the second network device is authorized to configure the parameter for the target PINE according to the authorization profile obtained based on the identifier of the target PINE, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

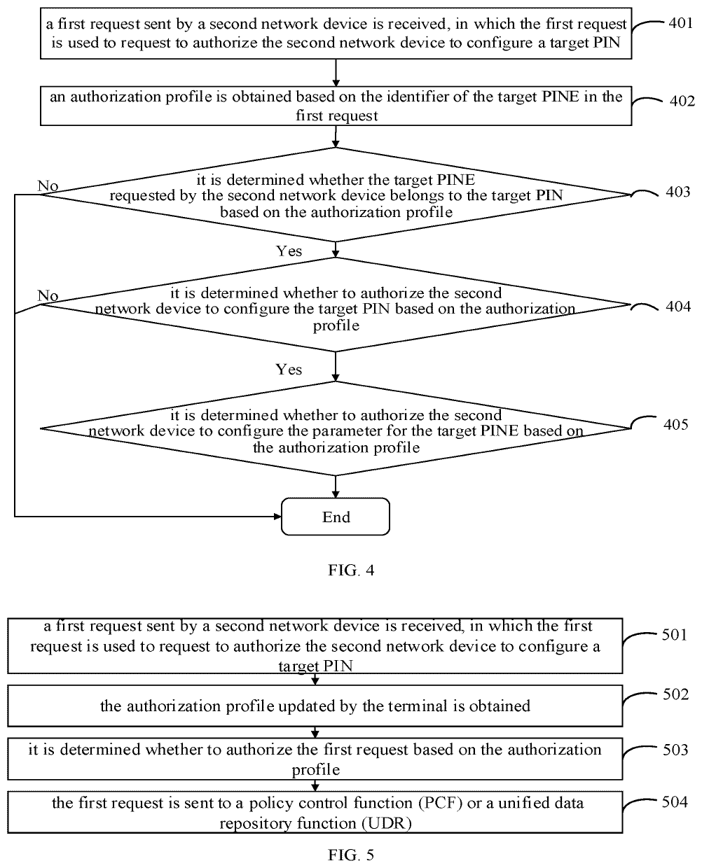

FIG. 4 is a flow chart of a method for authorizing an application function provided in an embodiment of the present disclosure. It should be noted that the method for authorizing an application function in an embodiment of the present disclosure is performed by the first network device. The method may be executed independently or in combination with any other embodiment of the present disclosure. As shown in FIG. 4, the method may include the following steps.

Step 401, a first request sent by a second network device is received, in which the first request is used to request to authorize the second network device to configure a target PIN.

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device is at least one of the following: PCF, NEF, UDR, CAPIF core function, NRF. The second network device is an application function AF, which may be deployed by an operator and may be an intranet AF (trusted) or an extranet AF (untrusted).

In an embodiment of the present disclosure, the first network device may obtain the authorization profile based on the first request.

Step 402, an authorization profile is obtained based on the identifier of the target PINE in the first request.

In an embodiment of the present disclosure, the first network device may obtain the corresponding authorization profile based on the identifier of the target PINE in the first request, and determine whether to authorize the first request of the second network device based on the information in the authorization profile.

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In an embodiment of the present disclosure, the profile updated by the terminal includes: an identifier of the terminal, identifiers of second network devices allowed to configure the parameter for the terminal, information of the PIN to which the terminal belongs, and an identifier of the second network device allowed to configure the PIN to which the terminal belongs.

The information of the PIN to which the terminal belongs includes at least one of: an identifier of the PIN to which the terminal belongs; an identifier of the PEGC in the PIN to which the terminal belongs; an identifier of the PEMC in the PIN to which the terminal belongs; an identifier of the regular PINE in the PIN to which the terminal belongs; or an association relationship between the regular PINE and PEGC in the PIN to which the terminal belongs.

In some implementations, the target PINE is a PEMC or a PEGC, and the authorization profile obtained by the first network device is an authorization profile updated by the target PINE.

In some implementations, the target PINE is a regular PINE, and the authorization profile obtained by the first network device is an authorization profile of a PEGC associated with the target PINE.

In some implementations, on a control plane, the first network device may subscribe to a notification from a unified data management (UDM) regarding an update of the authorization profile. The first network device may also cancel the subscription. In response to updating the authorization profile by the terminal, the first network device may receive a notification sent by the UDM, and the notification may include the authorization profile updated by the terminal.

In some implementations, on a user plane, the first network device may send a second request to a third network device, the second request is used to request an authorization profile updated by the terminal. The second request includes an identifier of the terminal (that is, an identifier of the PEMC in the target PIN in the first request), and the first network device may receive the authorization profile updated by the terminal and sent by the third network device.

The third network device may store the authorization profile generated or updated by each terminal and the identifier of the terminal corresponding to each authorization profile. The third network device may also be an application function deployed by the operator, for example, the third network device may be an authorization profile management function (APMF).

Step 403, it is determined whether the target PINE requested by the second network device belongs to the target PIN based on the authorization profile.

In an embodiment of the present disclosure, the second network device requests to configure the parameter for the target PINE (such as QoS, connection information related to the target PINE, URSP rules related to the target PINE, etc.), and after the first network device obtains the authorization profile based on the identifier of the target PIN E in the first request, the first network device may obtain the information of the PIN to which the target PINE belongs in the authorization profile. The first network device may determine whether the target PINE belongs to the target PIN based on the information of the PIN to which the target PINE belongs in the authorization profile.

The PIN information of the target PINE in the authorization profile may include at least one of: the identifier of the PIN to which the target PINE belongs, the identifier of the PEGC in the PIN to which the target PINE belongs, the identifier of the PEMC in the PIN to which the target PINE belongs, the identifier of the regular PINE in the PIN to which the target PINE belongs, and the association relationship between the regular PINE and the PEGC in the PIN to which the target PINE belongs. Therefore, the first network device may determine whether the identifier of the PIN to which the target PINE belongs matches the identifier of the target PIN in the first request based on the authorization profile, and then determine whether the target PINE belongs to the target PIN.

It is understandable that if the target PINE is a regular PINE, the first request includes at least one of: an identifier of the target PINE (including the identifier of the regular PINE and the identifier of the PEGC associated with the regular PINE) and an identifier of the target PIN. The first network device may determine whether the target PINE belongs to the target PIN by comparing the identifier in the first request based on the association relationship between the regular PINE and the PEGC in the authorization profile and the attribution relationship between the regular PINE and the PIN.

It is understandable that if it is determined that the target PINE does not belong to the target PIN, the first request is rejected and the authorization process is terminated.

Step 404, it is determined whether to authorize the second network device to configure the target PIN based on the authorization profile.

In an embodiment of the present disclosure, the target PINE belongs to the target PIN, and the PIN to which the target PINE belongs is the target PIN. The first network device may determine whether the identifier of the second network device sending the first request is within a permitted range based on the identifier of the second network device allowed to configure the target PIN in the authorization profile, and then determine whether to authorize the second network device to configure the target PIN.

It may be understood that if the identifier of the second network device sending the first request is not within the permitted range, the first request is rejected and the authorization process is terminated.

Step 405, it is determined whether to authorize the second network device to configure the parameter for the target PINE based on the authorization profile.

In some implementations, the target PINE is PEMC or PEGC, the second network device is requested to configure the parameter for the target PINE, and the authorization profile obtained by the first network device is an authorization profile updated by the target PINE.

The authorization profile updated by the target PINE includes an identifier of the second network device allowed to configure the parameter for the target PINE. The first network device may determine whether the identifier of the second network device sending the first request is within a permitted range based on the identifier of the second network device allowed to configure the parameter for the target PINE included in the authorization profile updated by the target PINE.

It may be understood that if the identifier of the second network device sending the first request is within the permitted range, the second network device is authorized to configure the parameter for the target PINE, the first request is authorized, and the authorization process is completed; if the identifier of the second network device sending the first request is not within the permitted range, the first request is rejected and the authorization process is terminated.

In some implementations, the target PINE is a regular PINE for which the second network device is requested to configure the parameter, and the authorization profile obtained by the first network device is an authorization profile of a PEGC associated with the target PINE.

The authorization profile updated by the PEGC associated with the target PINE includes an identifier of the second network device allowed to configure the parameter for the PEGC associated with the target PINE.

It should be noted that the second network device needs to configure the parameter for the regular PINE through the PEGC associated with the regular PINE, so the second network device allowed to configure the parameter for PEGC is also allowed to configure the parameter for the regular PINE. The first network device may determine whether the identifier of the second network device sending the first request is within the permitted range based on the identifier of the second network device allowed to configure the parameter for the PEGC associated with the target PINE, which is included in the authorization profile updated by the PEGC associated with the target PINE.

It may be understood that if the identifier of the second network device sending the first request is within the permitted range, the second network device is authorized to configure the parameters for the target PINE, the first request is authorized, and the authorization process is completed; if the identifier of the second network device sending the first request is not within the permitted range, the first request is rejected and the authorization process is terminated.

It may be understood that in an embodiment of the present disclosure, if the first request does not include the identifier of the target PINE, that is, the second network device does not further request to configure the parameter for the target PINE, and then the first network device obtains the authorization profile based on the identifier of the PEMC in the target PIN in the first request, and determines whether to authorize the second network device to configure the target PIN based on the authorization profile.

It should be noted that, in an embodiment of the present disclosure, the aforementioned steps 403-405 are the first network device verifying the first request based on the obtained authorization profile to confirm whether to authorize the first request. Execution of some or all of the aforementioned steps 403-405 are within the protection scope of the present disclosure. Moreover, the execution order of steps 403-405 is not limited in this embodiment, for example, steps 403 and 405 may be executed at the same time, or step 403 is executed before step 405, or step 405 is executed before step 403, which is not limited in this embodiment. In the process of executing the above steps, as long as the first network device rejects the request in a certain verification step, the authorization process is directly terminated and the subsequent verification steps are no longer executed. As long as the first network device passes the authorization in each verification step, the authorization of the first request may be finally confirmed. Any execution order and combination of any one or more of the above steps are within the protection scope of the present disclosure.

In summary, by receiving the first request sent by the second network device, in which the first request is used to request authorization for the second network device to configure the target PIN, an authorization profile is obtained based on the identifier of the target PINE in the first request, and it is determined whether the target PINE requested by the second network device belongs to the target PIN based on the authorization profile, and it is determined whether the second network device is authorized to configure the target PIN based on the authorization profile, and it is determined whether the second network device is authorized to configure the parameter for the target PINE based on the authorization profile obtained based on the identifier of the target PINE, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 5 is a flow chart of a method for authorizing an application function provided in an embodiment of the present disclosure. It should be noted that the method for authorizing an application function in an embodiment of the present disclosure is performed by the first network device. The method may be executed independently or in combination with any other embodiment of the present disclosure. As shown in FIG. 5, the method may include the following steps.

Step 501, a first request sent by a second network device is received, in which the first request is used to request to authorize the second network device to configure a target PIN.

In an embodiment of the present disclosure, the first network device is a network exposure function (NEF), and the second network device is an untrusted AF (outside the operator domain).

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device may obtain the authorization profile based on the first request.

Step 502, the authorization profile updated by the terminal is obtained.

In an embodiment of the present disclosure, the NEF may obtain the authorization profile based on the method described in any one of the embodiments of FIG. 2 to FIG. 4 of the present disclosure.

Step 503, it is determined whether to authorize the first request based on the authorization profile.

In an embodiment of the present disclosure, the NEF may determine whether to authorize the first request based on the authorization profile according to the method described in any one of the embodiments of FIG. 2 to FIG. 4 of the present disclosure.

In an embodiment of the present disclosure, after the NEF determines to authorize the first request, step 504 is executed; otherwise, the first request is rejected.

Step 504, the first request is sent to a policy control function (PCF) or a unified data repository function (UDR).

In an embodiment of the present disclosure, after determining to authorize the first request, the NEF may also send the first request to the PCF or the UDR.

It should be noted that after receiving the first request sent by NEF, PCF or UDR may directly acknowledge the authorization result of NEF and authorize the first request; or perform the authorization process again according to the method described in any of the embodiments of FIGS. 2 to 4 of the present disclosure to confirm whether to authorize the first request.

In summary, by receiving the first request sent by the second network device, in which the first request is used to request authorization for the second network device to configure the target PIN, the authorization profile updated by the terminal is obtained, and it is determined whether to authorize the first request based on the authorization profile, and to send the first request to the PCF or the UDR, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

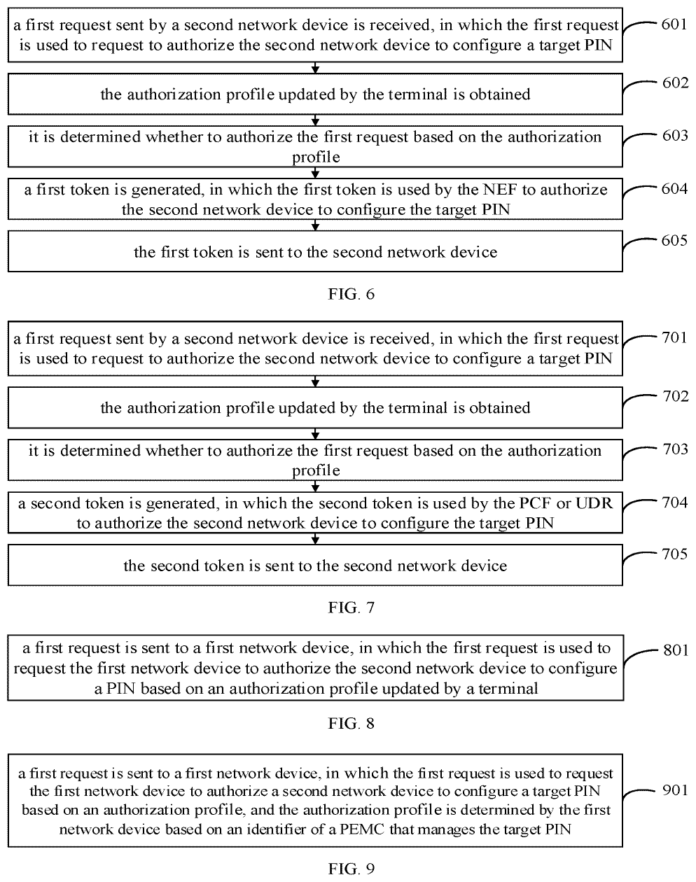

FIG. 6 is a flowchart of a method for authorizing an application function provided in an embodiment of the present disclosure. It should be noted that the method for authorizing an application function in an embodiment of the present disclosure is performed by the first network device. The method may be executed independently or in combination with any other embodiment of the present disclosure. As shown in FIG. 6, the method may include the following steps.

Step 601, a first request sent by a second network device is received, in which the first request is used to request to authorize the second network device to configure a target PIN.

In an embodiment of the present disclosure, the first network device is a CAPIF core function, and the second network device is an untrusted AF (outside the operator domain).

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device may obtain the authorization profile based on the first request.

Step 602, the authorization profile updated by the terminal is obtained.

In an embodiment of the present disclosure, the CAPIF core function may obtain the authorization profile according to the method described in any one of the embodiments of FIGS. 2 to 4 of the present disclosure.

Step 603, it is determined whether to authorize the first request based on the authorization profile.

In an embodiment of the present disclosure, the CAPIF core function may determine whether to authorize the first request based on the authorization profile according to the method described in any one of the embodiments of FIGS. 2 to 4 of the present disclosure.

In an embodiment of the present disclosure, after the CAPIF core function determines to authorize the first request, step 604 is executed, otherwise the first request is rejected.

Step 604, a first token is generated, in which the first token is used by the NEF to authorize the second network device to configure the target PIN.

In an embodiment of the present disclosure, after the CAPIF core function determines to authorize the first request, the CAPIF core function may generate a first token and send the first token to the second network device. The first token is used by the NEF to authorize the second network device to configure the target PIN.

Step 605, the first token is sent to the second network device.

In an embodiment of the present disclosure, the first token is used by the NEF to authorize the second network device to configure the target PIN.

Further, after the NEF authorizes the second network device to configure the target PIN, the second network device may provide the PCF or the UDR with the parameter for configuring the target PIN (such as the first parameter in the first request).

In summary, by receiving the first request sent by the second network device, in which the first request is used to request to authorize the second network device to configure the target PIN, the authorization profile updated by the terminal is obtained, and it is determined whether to authorize the first request based on the authorization profile. A first token is generated, which is used by NEF to authorize the second network device to configure the target PIN. The first token is sent to the second network device, so that the first network device may verify whether the access of the second network device is allowed based on the authorization of the resource owner, that is, the terminal, and the access of the second network device may be limited to the level of a specific network and resource owner, thereby ensuring the privacy and security of the PIN, while ensuring the security of the communication system.

FIG. 7 is a flowchart of a method for authorizing an application function provided in an embodiment of the present disclosure. It should be noted that the method for authorizing an application function in an embodiment of the present disclosure is performed by the first network device. The method may be executed independently or in combination with any other embodiment of the present disclosure. As shown in FIG. 7, the method may include the following steps.

Step 701, a first request sent by a second network device is received, in which the first request is used to request to authorize the second network device to configure a target PIN.

In an embodiment of the present disclosure, the first network device is an NRF, and the second network device is a trusted AF (within the operator domain).

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device may obtain the authorization profile based on the first request.

Step 702, the authorization profile updated by the terminal is obtained.

In an embodiment of the present disclosure, the NRF may obtain the authorization profile according to the method described in any one of the embodiments of FIGS. 2 to 4 of the present disclosure.

Step 703, it is determined whether to authorize the first request based on the authorization profile.

In an embodiment of the present disclosure, the NRF may determine whether to authorize the first request based on the authorization profile according to the method described in any one of the embodiments of FIGS. 2 to 4 of the present disclosure.

In an embodiment of the present disclosure, after the NRF determines to authorize the first request, step 704 is executed, otherwise the first request is rejected.

Step 704, a second token is generated, in which the second token is used by the PCF or UDR to authorize the second network device to configure the target PIN.

In an embodiment of the present disclosure, after the NRF determines to authorize the first request, it may generate a second token and send the second token to the second network device. The second token is used by the PCF or UDR to authorize the second network device to configure the target PIN.

Step 705, the second token is sent to the second network device.

In an embodiment of the present disclosure, the second token is used by the PCF or UDR to authorize the second network device to configure the target PIN. The second network device may provide the PCF or UDR with the parameter for configuring the target PIN (such as the first parameter in the first request) through the second token.

In summary, by receiving the first request sent by the second network device, in which the first request is used to request to authorize the second network device to configure the target PIN, the authorization profile updated by the terminal is obtained, and it is determined whether to authorize the first request based on the authorization profile. A second token is generated, which is used by the PCF or UDR to authorize the second network device to configure the target PIN. The second token is sent to the second network device, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 8 is a flowchart of a method for authorizing an application function provided in an embodiment of the present disclosure. It should be noted that the method for authorizing an application function in an embodiment of the present disclosure is performed by the second network device. The method may be executed independently or in combination with any other embodiment of the present disclosure. As shown in FIG. 8, the method may include the following steps.

Step 801, a first request is sent to a first network device, in which the first request is used to request the first network device to authorize the second network device to configure a PIN based on an authorization profile updated by a terminal.

In an embodiment of the present disclosure, the second network device may send a first request to the first network device, and the second network device requests the first network device to authorize the second network device to configure a PIN.

The first request may include at least one of:
an identifier of the second network device; an identifier of a target PIN; an identifier of PEMC in the target PIN; an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

In an embodiment of the present disclosure, the first network device is at least one of: PCF, NEF, UDR, CAPIF core function, or NRF. The second network device is an application function AF, which may be deployed by an operator and may be an intranet AF (trusted) or an extranet AF (untrusted).

In some implementations, the first request may also be used by the first network device to obtain an authorization profile based on the first request.

In an embodiment of the present disclosure, the first network device may obtain the authorization profile updated by the terminal, and determine whether to authorize the first request of the second network device based on the information in the authorization profile.

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In some implementations, if the terminal is a PEGC, the profile updated by the terminal includes: an identifier of the terminal, and an identifier of the second network device allowed to configure a parameter for the terminal.

If the terminal is a PEMC, the profile updated by the terminal includes: an identifier of the terminal, an identifier of the second network device allowed to configure the parameter for the terminal, information of the PIN managed by the terminal, and an identifier of the second network device allowed to configure the PIN managed by the terminal.

The information of the PIN managed by the terminal includes at least one of: an identifier of the PIN managed by the terminal; an identifier of the PEGC in the PIN managed by the terminal; an identifier of the PEMC in the PIN managed by the terminal; an identifier of the regular PINE in the PIN managed by the terminal; and an association relationship between the regular PINE and PEGC in the PIN managed by the terminal.

In some embodiments, the profile updated by the terminal includes: an identifier of the terminal, an identifier of the second network device allowed to configure the parameter for the terminal, information of the PIN to which the terminal belongs, and an identifier of the second network device allowed to configure the PIN to which the terminal belongs.

The information of the PIN to which the terminal belongs includes at least one of: the identifier of the PIN to which the terminal belongs; the identifier of the PEGC in the PIN to which the terminal belongs; the identifier of the PEMC in the PIN to which the terminal belongs; the identifier of the regular PINE in the PIN to which the terminal belongs; and the association relationship between the regular PINE and PEGC in the PIN to which the terminal belongs.

In an embodiment of the present disclosure, as an example, the identifier of the terminal may be an SUPI, an SUCI, a GPSI, an IMPI, etc.

In some implementations, the first network device may obtain the authorization profile updated by the PEMC based on the identifier of the PEMC in the target PIN in the first request, and determine whether to authorize the first request based on the obtained authorization profile.

In an embodiment of the present disclosure, the first network device may determine whether to authorize the first request sent by the second network device based on the obtained authorization profile, and determine whether to authorize the second network device to configure the target PIN and/or configure the parameter for the target PINE.

In some implementations, the first network device may confirm whether the second network device is allowed to configure the target PIN based on the authorization profile.

In some implementations, the first network device may confirm whether the target PINE requested by the second network device belongs to the target PIN based on the authorization profile.

In some implementations, the first network device may confirm whether the second network device is allowed to configure the parameter for the target PINE based on the authorization profile.

In summary, by sending a first request to the first network device, in which the first request is used to request the first network device to authorize the second network device to configure the PIN based on the authorization profile updated by the terminal, the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 9 is a flowchart of a method for authorizing an application function provided in an embodiment of the present disclosure. It should be noted that the method for authorizing an application function in an embodiment of the present disclosure is performed by the second network device. The method may be executed independently or in combination with any other embodiment of the present disclosure. As shown in FIG. 9, the method may include the following steps.

Step 901, a first request is sent to a first network device, in which the first request is used to request the first network device to authorize a second network device to configure a target PIN based on an authorization profile, and the authorization profile is determined by the first network device based on an identifier of a PEMC that manages the target PIN.

In an embodiment of the present disclosure, the second network device may send a first request to the first network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device is at least one of: PCF, NEF, UDR, CAPIF core function, or NRF. The second network device is an application function AF, which may be deployed by an operator and may be an intranet AF (trusted) or an extranet AF (untrusted).

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In an embodiment of the present disclosure, the first network device may obtain the authorization profile corresponding to the PEMC based on the identifier of the PEMC in the target PIN in the first request, and determine whether to authorize the first request of the second network device based on the information in the authorization profile.

The profile updated by the PEGC includes: an identifier of the PEGC and an identifier of the second network device allowed to configure a parameter for the PEGC (such as an AF ID, an application layer ID, etc.).

The profile updated by PEMC includes: the identifier of the PEMC, an identifier of the second network device allowed to configure the parameter for the PEMC (such as AF ID, application layer ID, etc.), the information of the PIN managed by the PEMC, and an identifier of the second network device allowed to configure the PIN managed by the PEMC (such as AF ID, application layer ID, etc.).

The information of the PIN managed by the PEMC includes at least one of: the identifier of the PIN managed by the PEMC; the identifier of the PEGC in the PIN managed by the PEMC; the identifier of the PEMC in the PIN managed by the PEMC; the identifier of the regular PINE in the PIN managed by the PEMC; the association relationship between the regular PINE and PEGC in the PIN managed by the PEMC.

In summary, by sending a first request to the first network device, in which the first request is used to request the first network device to authorize the second network device to configure the target PIN based on the authorization profile, and the authorization profile is determined by the first network device based on the identifier of the PEMC that manages the target PIN, the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

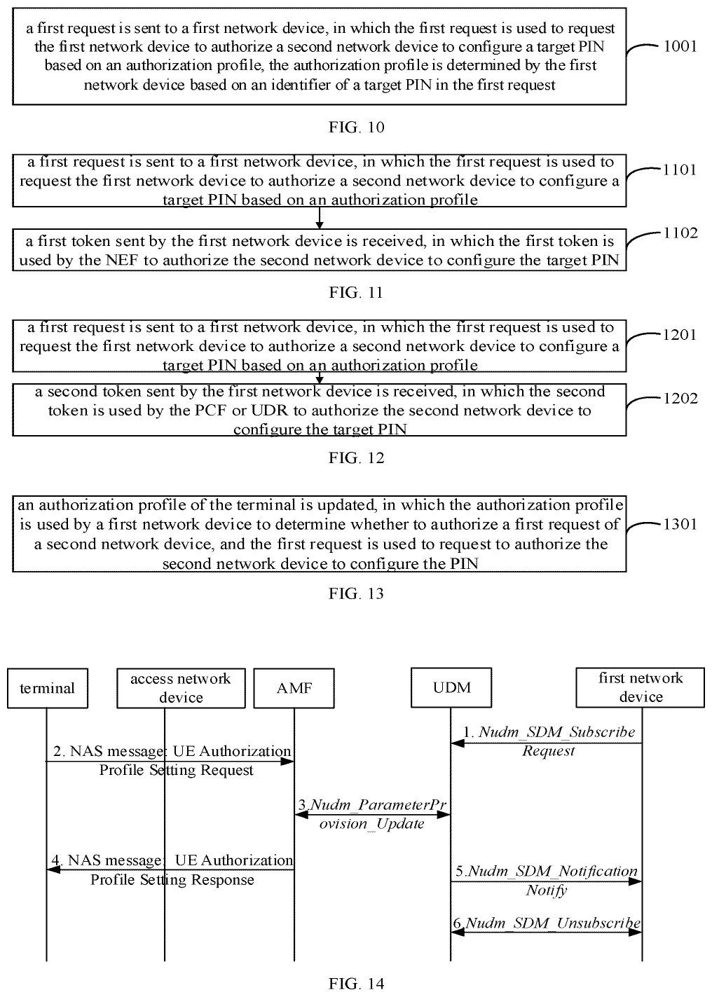

FIG. 10 is a flow chart of a method for authorizing an application function provided in an embodiment of the present disclosure. It should be noted that the method for authorizing an application function in an embodiment of the present disclosure is performed by the second network device. The method may be executed independently or in combination with any other embodiment of the present disclosure. As shown in FIG. 10, the method may include the following steps.

Step 1001, a first request is sent to a first network device, in which the first request is used to request the first network device to authorize a second network device to configure a target PIN based on an authorization profile, and the authorization profile is determined by the first network device based on an identifier of a target PIN in the first request.

In an embodiment of the present disclosure, the second network device may send a first request to the first network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device is at least one of: PCF, NEF, UDR, CAPIF core function, or NRF. The second network device is an application function AF, which may be deployed by an operator and may be an intranet AF (trusted) or an extranet AF (untrusted).

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In an embodiment of the present disclosure, the first network device may obtain the corresponding authorization profile based on the identifier of the target PINE in the first request, and determine whether to authorize the first request of the second network device based on the information in the authorization profile.

The profile updated by the terminal includes: an identifier of the terminal, an identifier of the second network device allowed to configure the parameter for the terminal, information of the PIN to which the terminal belongs, and an identifier of the second network device allowed to configure the PIN to which the terminal belongs.

The information of the PIN to which the terminal belongs includes at least one of: the identifier of the PIN to which the terminal belongs; the identifier of the PEGC in the PIN to which the terminal belongs; the identifier of the PEMC in the PIN to which the terminal belongs; the identifier of the regular PINE in the PIN to which the terminal belongs; and the association relationship between the regular PINE and PEGC in the PIN to which the terminal belongs.

In an implementation, the target PINE is PEMC or PEGC, and the authorization profile obtained by the first network device is an authorization profile updated by the target PINE.

In an implementation, the target PINE is a regular PINE, and the authorization profile obtained by the first network device is an authorization profile of a PEGC associated with the target PINE.

In summary, by sending a first request to the first network device, in which the first request is used to request the first network device to authorize the second network device to configure the target PIN based on the authorization profile, and the authorization profile is determined by the first network device based on the identifier of the target PIN in the first request, the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 11 is a flow chart of a method for authorizing an application function provided in an embodiment of the present disclosure. It should be noted that the method for authorizing an application function in an embodiment of the present disclosure is performed by the second network device. The method may be executed independently or in combination with any other embodiment of the present disclosure. As shown in FIG. 11, the method may include the following steps.

Step 1101, a first request is sent to a first network device, in which the first request is used to request the first network device to authorize a second network device to configure a target PIN based on an authorization profile.

In an embodiment of the present disclosure, the first network device is a CAPIF core function, and the second network device is an untrusted AF (outside the operator domain).

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the first network device may obtain the authorization profile based on the first request.

In an embodiment of the present disclosure, the CAPIF core function may obtain an authorization profile based on the method described in any of the aforementioned embodiments of the present disclosure, and determine whether to authorize the first request based on the authorization profile.

Step 1102, a first token sent by the first network device is received, in which the first token is used by the NEF to authorize the second network device to configure the target PIN.

In an embodiment of the present disclosure, after the CAPIF core function determines to authorize the first request, a first token is generated and sent to the second network device. The second network device may receive the first token sent by CAPIF, and the first token is used by NEF to authorize the second network device to configure the target PIN.

It may be understood that in an embodiment of the present disclosure, after obtaining the first token, the second network device may send a first request and a first token to the NEF. After receiving the first token, the NEF may confirm to authorize the second network device to configure the target PIN. The second network device may provide the PCF or UDR with parameters for configuring the target PIN (such as the first parameter in the first request).

In summary, by sending a first request to the first network device, in which the first request is used to request the first network device to authorize the second network device to configure the target PIN based on the authorization profile, the first token sent by the first network device is received. The first token is used for the NEF to authorize the second network device to configure the target PIN, so that the first network device may verify whether the access of the second network device is allowed based on the authorization of the resource owner, that is, the terminal, and the access of the second network device may be limited to the level of a specific network and resource owner, thereby ensuring the privacy and security of the PIN, while ensuring the security of the communication system.

FIG. 12 is a flow chart of a method for authorizing an application function provided in an embodiment of the present disclosure. It should be noted that the method for authorizing an application function in an embodiment of the present disclosure is performed by the second network device. The method may be executed independently or in combination with any other embodiment of the present disclosure. As shown in FIG. 12, the method may include the following steps.

Step 1201, a first request is sent to a first network device, in which the first request is used to request the first network device to authorize a second network device to configure a target PIN based on an authorization profile.

In an embodiment of the present disclosure, the first network device is an NRF, and the second network device is a trusted AF (within the operator domain).

In an embodiment of the present disclosure, the first network device is capable of receiving a first request sent by the second network device, and the second network device requests the first network device to authorize the second network device to configure a PIN.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the NRF may obtain an authorization profile according to the method described in any of the aforementioned embodiments of the present disclosure, and determine whether to authorize the first request based on the authorization profile.

Step 1202, a second token sent by the first network device is received, in which the second token is used by the PCF or UDR to authorize the second network device to configure the target PIN.

In an embodiment of the present disclosure, after the NRF determines to authorize the first request, a second token is generated and sent to the second network device. The second network device may receive the second token sent by the NRF, and the second token is used by the PCF or UDR to authorize the second network device to configure the target PIN.

It may be understood that in an embodiment of the present disclosure, after obtaining the second token, the second network device may provide the parameters for configuring the target PIN (such as the first parameter in the first request) to the PCF or UDR through the second token.

In summary, by sending a first request to the first network device, in which the first request is used to request the first network device to authorize the second network device to configure the target PIN based on the authorization profile, the second token sent by the first network device is received. The second token is used by PCF or UDR to authorize the second network device to configure the target PIN, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 13 is a flowchart of a method for authorizing an application function provided in an embodiment of the present disclosure. It should be noted that the method for authorizing an application function in an embodiment of the present disclosure is performed by a terminal. The method may be executed independently or in combination with any other embodiment of the present disclosure. As shown in FIG. 13, the method may include the following steps.

Step 1301, an authorization profile of the terminal is updated, in which the authorization profile is used by a first network device to determine whether to authorize a first request of a second network device, and the first request is used to request to authorize the second network device to configure the PIN.

In an embodiment of the present disclosure, the first network device is capable of receiving a first request sent by the second network device, and the second network device requests the first network device to authorize the second network device to configure a PIN.

In an embodiment of the present disclosure, the first network device is at least one of the following: PCF, NEF, UDR, CAPIF core function, or NRF. The second network device is an application function AF, which may be deployed by an operator and may be an intranet AF (trusted) or an extranet AF (untrusted).

In an embodiment of the present disclosure, the first network device may obtain the authorization profile updated by the terminal, and determine whether to authorize the first request of the second network device based on the information in the authorization profile.

The first request may include at least one of:
an identifier of the second network device; an identifier of a target PIN (such as PIN ID); an identifier of PEMC in the target PIN (such as the GPSI of PEMC, PEMC ID, etc.); an identifier of a target PINE; a first parameter used to configure the target PINE.

In an implementation, the first parameter may include at least one of: QoS, connection information related to the target PINE, or URSP rules related to the target PINE.

The target PIN refers to a PIN which the second network device is requested to be authorized to configure, and the target PINE refers to a PINE for which the second network device is requested to be authorized to configure a parameter, that is, the second network device requests to configure the target PIN and requests to configure the parameter for the target PINE.

As an implementation, the target PINE is a PEMC, and the identifier of the target PINE may be the GPSI of the PEMC, PEMC ID and so on.

As an implementation, the target PINE is a PEGC, and the identifier of the target PINE may be the GPSI of the PEGC, PEGC ID and so on.

As an implementation, the target PINE is a regular PINE, and the identifier of the target PINE may include the PINE ID of the regular PINE and the identifier of the PEGC associated with the target PINE (such as the GPSI of the PEGC, PEGC ID, etc.).

In an embodiment of the present disclosure, the authorization profile is generated and updated by the terminal, and may be used to verify whether the second network device may configure and manage a specific PIN.

In various embodiments of the present disclosure, the terminal is a PIN element with a management capability (PEMC), or a PIN element with a gateway capability (PEGC).

It should be noted that in PIN, PEMC (or PEGC) may generate and update the authorization profile corresponding to the PEMC (or PEGC), while the regular PINE cannot generate and update the authorization profile.

In some implementations, if the terminal is a PEGC, the profile updated by the terminal includes: an identifier of the terminal, and an identifier of the second network device allowed to configure a parameter for the terminal.

If the terminal is a PEMC, the profile updated by the terminal includes: an identifier of the terminal, an identifier of the second network device allowed to configure the parameter for the terminal, information of the PIN managed by the terminal, and an identifier of the second network device allowed to configure the PIN managed by the terminal.

The information of the PIN managed by the terminal includes at least one of: an identifier of the PIN managed by the terminal; an identifier of the PEGC in the PIN managed by the terminal; an identifier of the PEMC in the PIN managed by the terminal; an identifier of the regular PINE in the PIN managed by the terminal; and an association relationship between the regular PINE and PEGC in the PIN managed by the terminal.

In some embodiments, the profile updated by the terminal includes: an identifier of the terminal, an identifier of the second network device allowed to configure the parameter for the terminal, information of the PIN to which the terminal belongs, and an identifier of the second network device allowed to configure the PIN to which the terminal belongs.

The information of the PIN to which the terminal belongs includes at least one of: the identifier of the PIN to which the terminal belongs; the identifier of the PEGC in the PIN to which the terminal belongs; the identifier of the PEMC in the PIN to which the terminal belongs; the identifier of the regular PINE in the PIN to which the terminal belongs; and the association relationship between the regular PINE and PEGC in the PIN to which the terminal belongs.

In an embodiment of the present disclosure, as an example, the identifier of the terminal may be an SUPI, an SUCI, a GPSI, an IMPI, etc.

In some implementations, the first network device may obtain the authorization profile updated by the PEMC based on the identifier of the PEMC in the target PIN in the first request, and determine whether to authorize the first request based on the obtained authorization profile.

In some embodiments, on a control plane, the terminal may send the authorization profile updated by the terminal to the UDM through the access network device and the AMF. The first network device may subscribe to the notification of the UDM about the update of the authorization profile. The first network device may also cancel the subscription. In response to the terminal updating the authorization profile, the first network device may receive the notification sent by the UDM, which may include the authorization profile updated by the terminal.

In some implementations, on a user plane, the terminal may send the authorization profile updated by the terminal to the third network device through the access network device. The first network device may send a second request to a third network device, the second request is used to request the authorization profile updated by the terminal, the second request includes the identifier of the terminal (that is, the identifier of the PEMC in the target PIN in the first request), and the first network device may receive the authorization profile updated by the terminal and sent by the third network device.

The third network device may store the authorization profiles generated or updated by each terminal and the identifier of the terminal corresponding to each authorization profile. The third network device may also be an application function deployed by the operator. For example, the third network device may be the authorization profile management function (APMF).

In summary, by updating the authorization profile of the terminal, in which the authorization profile is used by the first network device to determine whether to authorize the first request of the second network device, and the first request is used to request to authorize the second network device to configure a PIN, the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 14 is a flow chart of a method for obtaining an authorization profile on the control plane provided in an embodiment of the present disclosure. The method may be executed independently or in combination with any other embodiment of the present disclosure. As shown in FIG. 14, the method may include the following steps.
1. The first network device (at least one of PCF, NEF, UDR, CAPIF core function, or NRF) subscribes to the UDM notification about the update of the authorization profile through the Nudm_SDM_Subscribe Request message.
2. The terminal generates or updates the authorization profile. The terminal sends the newly updated part of authorization profile to the access and mobility management function (AMF) through the access network device via the UE Authorization profile Setting Request in the N1 NAS (non-access layer) message.
3. AMF calls the Nudm_ParameterProvision_Update service operation to the UDM, in which the service operation carries the updated part of the authorization profile. The UDM stores or updates the authorization profile in the UDR by calling the Nudr_DM_Update (SUPI/GPSI, subscription data) service operation accordingly.
4. AMF responds to the terminal via the UE Authorization Profile Setting Response in the N1 NAS message.
5. UDM notifies the first network device subscribing to the notification of the authorization profile updated by the terminal via a Nudm_SDM_Notification Notify message.
6. The first network device may unsubscribe from the UDM notification about the authorization profile via the Nudm_SDM_Unsubscribe message.

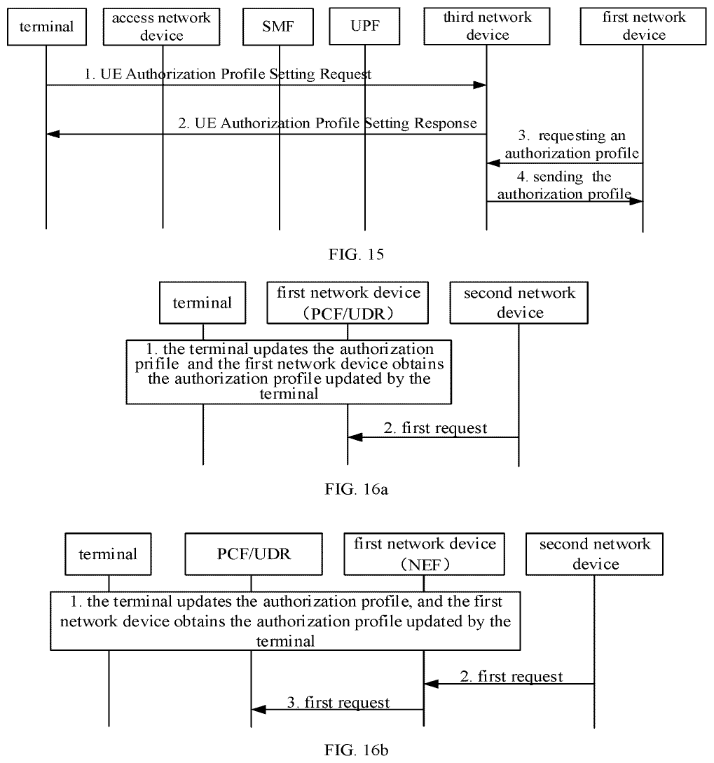

FIG. 15 is a flowchart of a method for obtaining an authorization profile on the control plane provided in an embodiment of the present disclosure. The method may be executed independently or in combination with any other embodiment of the present disclosure. As shown in 15, the method may include the following steps.
1. If the terminal (UE) generates or updates an authorization profile, the terminal sends the updated part of the authorization profile together with the identifier of the terminal (such as GPSI) to the third network device via a UE Authorization Profile Setting Request.

The third network device is an application function AF (such as an authorization profile management function APMF) deployed by an operator, and the operator may provide the address of the third network device to the terminal.
2. The third network device stores the authorization profile and is capable of sending a UE Authorization Profile Setting Response to the terminal.
3. The first network device (at least one of PCF, NEF, UDR, CAPIF core function, and NRF) may request an authorization profile (Profile Request) updated by a specific terminal via the identifier of the terminal (e.g., GPSI).
4. The third network device sends the corresponding authorization profile to the first network device (Profile Response).

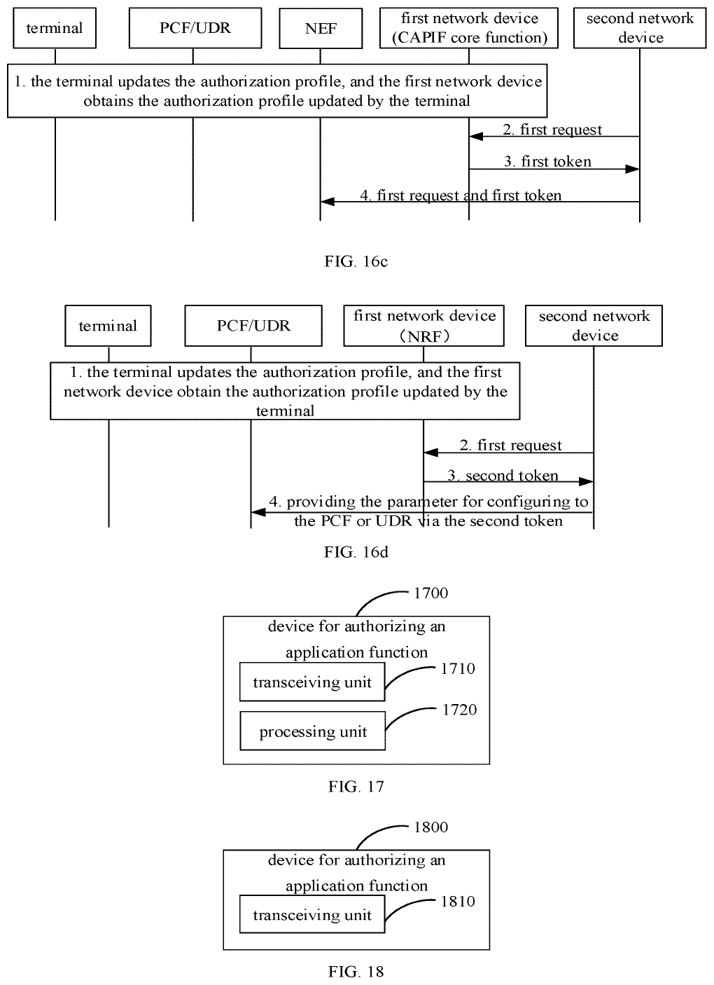

FIG. 16a is a flowchart of a method for authorizing an application function provided in an embodiment of the present disclosure. The method may be executed independently or in combination with any other embodiment of the present disclosure. As shown in FIG. 16a, the method may include the following steps.
1. The terminal may update the authorization profile according to the method described in any embodiment of the present disclosure, and the first network device may obtain the authorization profile updated by the terminal according to the method described in any embodiment of the present disclosure.
2. The first network device (PCF/UDR) may receive a first request sent by the second network device for authorizing to configure a target PIN, and may determine whether to authorize the first request according to the method described in any embodiment of the present disclosure.

The second network device may be trusted.

Further, after authorizing the first request, the second network device may provide the PCF or UDR with the parameter for configuring the target PIN (such as the first parameter in the first request).

FIG. 16b is a flowchart of a method for authorizing an application function provided in an embodiment of the present disclosure. The method may be executed independently or in combination with any other embodiment of the present disclosure. As shown in FIG. 16b, the method may include the following steps.
1. The terminal may update the authorization profile according to the method described in any embodiment of the present disclosure, and the first network device may obtain the authorization profile updated by the terminal according to the method described in any embodiment of the present disclosure.
2. The first network device (NEF) may receive a first request sent by the second network device for authorizing to configure a target PIN, and may determine whether to authorize the first request according to the method described in any embodiment of the present disclosure.
3. After determining to authorize the first request, NEF may send the first request to PCF/UDR.

In an implementation, after receiving the first request, the PCF/UDR may directly acknowledge the authorization result of the NEF and authorize the first request; or the PCF/UDR may perform the authorization process again according to the method described in any embodiment of the present disclosure to confirm whether to authorize the first request.

Further, after authorizing the first request, the second network device may provide the PCF or UDR with the parameter for configuring the target PIN (such as the first parameter in the first request).

FIG. 16c is a flowchart of a method for authorizing an application function provided in an embodiment of the present disclosure. The method may be executed independently or in combination with any other embodiment of the present disclosure. As shown in FIG. 16c, the method may include the following steps.
1. The terminal may update the authorization profile according to the method described in any embodiment of the present disclosure, and the first network device may obtain the authorization profile updated by the terminal according to the method described in any embodiment of the present disclosure.
2. The first network device (CAPIF core function) may receive a first request sent by the second network device for authorizing to configure a target PIN, and may determine whether to authorize the first request according to the method described in any embodiment of the present disclosure.
3. After the CAPIF core function determines that the first request is authorized, a first token is generated and sent to the second network device.
4. The second network device may send the first request and the first token to the NEF, and the NEF authorizes the first request based on the first token.

Further, after authorizing the first request, the second network device may provide the PCF or UDR with the parameter for configuring the target PIN (such as the first parameter in the first request).

FIG. 16d is a flowchart of a method for authorizing an application function provided in an embodiment of the present disclosure. The method may be executed independently or in combination with any other embodiment of the present disclosure. As shown in FIG. 16d, the method may include the following steps.
1. The terminal may update the authorization profile according to the method described in any embodiment of the present disclosure, and the first network device may obtain the authorization profile updated by the terminal according to the method described in any embodiment of the present disclosure.
2. The first network device (NRF) may receive a first request sent by the second network device for authorizing to configure a target PIN, and may determine whether to authorize the first request according to the method described in any embodiment of the present disclosure.
3. After the NRF determines to authorize the first request, a second token is generated and sent to the second network device.
4. The second network device may provide the parameter for configuring the target PIN (such as the first parameter in the first request) to the PCF or UDR via the second token.

Corresponding to the method for authorizing an application functions provided in the above-mentioned embodiments, the present disclosure also provides a device for authorizing an application function. Since the device for authorizing an application function provided in the embodiments of the present disclosure corresponds to the methods provided in the above-mentioned embodiments, the implementation of the method for authorizing an application function is also applicable to the device for authorizing an application function provided in the following embodiments and will not be described in detail in the following embodiments.

FIG. 17 is a structural diagram of a device for authorizing an application function provided in an embodiment of the present disclosure.

As shown in FIG. 17, the device for authorizing an application function 1700 includes: a transceiving unit 1710 and a processing unit 1720.

The transceiving unit 1710 is configured to receive a first request sent by a second network device, in which the first request is used to request to authorize the second network device to configure a PIN.

The transceiving unit 1710 is also used to obtain an authorization profile updated by a terminal.

The processing unit 1720 is configured to determine whether to authorize the first request based on the authorization profile.

In an implementation, the first request includes at least one of at least one of: an identifier of the second network device; an identifier of a target PIN, in which the second network device is requested to be authorized to configure the target PIN; an identifier of a PIN element with a management capability in the target PIN; an identifier of a target PIN element, in which the target PIN element is a PIN element in the target PIN, and the second network device is requested to be authorized to configure a parameter for the PIN element in the target PIN; or a first parameter used to configure the target PIN element.

In an implementation, the terminal is the PIN element with the management capability, or the terminal is a PIN element with a gateway capability.

In an implementation, the authorization profile updated by the terminal includes: an identifier of the terminal, and an identifier of the second network device allowed to configure a parameter for the terminal.

In an implementation, the terminal is the PIN element with the management capability, and the authorization profile updated by the terminal further includes: information of a PIN managed by the terminal, and an identifier of the second network device allowed to configure the PIN managed by the terminal.

In an implementation, the information of the PIN managed by the terminal includes at least one of: an identifier of the PIN managed by the terminal; an identifier of a PIN element with the gateway capability in the PIN managed by the terminal; an identifier of a PIN element with the management capability in the PIN managed by the terminal; an identifier of a regular PIN element in the PIN managed by the terminal; or an association relationship between the regular PIN element and the PIN element with the gateway capability in the PIN managed by the terminal.

In an implementation, the authorization profile updated by the terminal includes: an identifier of the terminal, an identifier of the second network device allowed to configure a parameter for the terminal, information of a PIN to which the terminal belongs, and an identifier of the second network device allowed to configure the PIN to which the terminal belongs.

In an implementation, the information of the PIN to which the terminal belongs includes at least one of: an identifier of the PIN to which the terminal belongs; an identifier of a PIN element with the gateway capability in the PIN to which the terminal belongs; an identifier of a PIN element with the management capability in the PIN to which the terminal belongs; an identifier of a regular PIN element in the PIN to which the terminal belongs; an association relationship between the regular PIN element and the PIN element with the gateway capability in the PIN to which the terminal belongs.

In an implementation, the processing unit 1720 is also configured to: determine that the first request satisfies each of at least one preset condition, and authorizing the first request; determine that the first request does not satisfy any one of the at least one preset condition, and rejecting the first request; in which the at least one preset condition includes: determining that the second network device is authorized to configure the target PIN based on an identifier of the second network device allowed to configure the target PIN in the authorization profile.

In an implementation, the at least one preset condition further includes: determining that the target PIN element belongs to the target PIN based on the information of the target PIN in the authorization profile, in which the second network device is requested to configure the parameter for the target PIN element.

In an implementation, the at least one preset condition also includes: determining that the second network device is authorized to configure the parameter for the target PIN element based on an identifier of the second network device allowed to configure the parameter for the target PIN element in the authorization profile updated by the target PIN element; in which the target PIN element is the PIN element with the gateway capability, or the target PIN element is the PIN element with the management capability.

In an implementation, the at least one preset condition also includes: determining that the second network device is authorized to configure the parameter for the target PIN element based on an identifier of the second network device allowed to configure the parameter for the PIN element with the gateway capability associated with the target PIN element in the authorization profile; in which the authorization profile is updated by the PIN element with the gateway capability associated with the target PIN element, and the target PIN element is a regular PIN element.

In an implementation, the transceiving unit 1710 is specifically configured to: receive a notification sent by a unified data management (UDM), in which the notification includes the authorization profile updated by the terminal.

In an implementation, the transceiving unit 1710 is specifically configured to: send a second request to a third network device, in which the second request is used to request the authorization profile updated by the terminal, the second request includes an identifier of the terminal; and receive the authorization profile updated by the terminal and sent by the third network device.

In an implementation, the first network device is at least one of the following: a policy control function (PCF); a unified data repository function (UDR); a network exposure function (NEF); or a common application programming interface framework (CAPIF) core function.

In an implementation, the first network device is NEF, and the transceiving unit 1710 is further configured to: send the first request to the PCF or UDR.

In an implementation, the first network device is the CAPIF core function, and determines to authorize the second network device to configure the PIN. The transceiving unit 1710 is also configured to: generate a first token, in which the first token is used by the NEF to authorize the second network device to configure the PIN; and send the first token to the second network device.

In an implementation, the first network device is a network repository function (NRF), and determines to authorize the second network device to configure the PIN. The transceiving unit 1710 is also configured to: generate a second token, in which the second token is used by the PCF or the UDR to authorize the second network device to configure the PIN; and send the second token to the second network device.

The device for authorizing an application function of this embodiment may receive a first request sent by the second network device, in which the first request is used to request to authorize the second network device to configure a PIN, an authorization profile updated by the terminal is obtained, and it is determined whether to authorize the first request based on the authorization profile, so that the first network device may verify whether the access of the second network device is allowed based on the authorization of the resource owner, that is, the terminal, and the access of the second network device may be limited to a level of a specific network and resource owner, thereby effectively ensuring the privacy and security of the PIN, while ensuring the security of the communication system.

FIG. 18 is a structural diagram of a device for authorizing an application function provided in an embodiment of the present disclosure.

As shown in FIG. 18, the device for authorizing an application function 180 0 includes a transceiving unit 1810.

The transceiving unit 1810 is configured to send a first request to a first network device, in which the first request is used to request the first network device to authorize the second network device to configure a PIN based on an authorization profile updated by a terminal.

In an implementation, the first request includes at least one of: an identifier of the second network device; an identifier of a target PIN, wherein the second network device is requested to be authorized to configure the target PIN; an identifier of a PIN element with a management capability in the target PIN; an identifier of a target PIN element, in which the target PIN element is a PIN element in the target PIN, and the second network device is requested to be authorized to configure a parameter for the PIN element in the target PIN; or a first parameter used to configure the target PIN element.

In an implementation, the terminal is the PIN element with the management capability, or the terminal is a PIN element with a gateway capability.

In an implementation, the authorization profile updated by the terminal includes: an identifier of the terminal, and an identifier of the second network device allowed to configure a parameter for the terminal.

In an implementation, the terminal is the PIN element with the management capability, and the authorization profile updated by the terminal further includes: information of a PIN managed by the terminal, and an identifier of the second network device allowed to configure the PIN managed by the terminal.

In an implementation, the information of the PIN managed by the terminal includes at least one of: an identifier of the PIN managed by the terminal; an identifier of a PIN element with the gateway capability in the PIN managed by the terminal; an identifier of a PIN element with the management capability in the PIN managed by the terminal; an identifier of a regular PIN element in the PIN managed by the terminal; or an association relationship between the regular PIN element and the PIN element with the gateway capability in the PIN managed by the terminal.

In an implementation, the authorization profile updated by the terminal includes: an identifier of the terminal, an identifier of the second network device allowed to configure a parameter for the terminal, information of a PIN to which the terminal belongs, and an identifier of the second network device allowed to configure the PIN to which the terminal belongs.

In an implementation, the information of the PIN to which the terminal belongs includes at least one of: an identifier of the PIN to which the terminal belongs; an identifier of a PIN element with the gateway capability in the PIN to which the terminal belongs; an identifier of a PIN element with the management capability in the PIN to which the terminal belongs; an identifier of a regular PIN element in the PIN to which the terminal belongs; an association relationship between the regular PIN element and the PIN element with the gateway capability in the PIN to which the terminal belongs.

In an implementation, an identifier of the second network device allowed to configure the target PIN in the authorization profile is used to determine whether the second network device is authorized to configure the target PIN.

In an implementation, the information of the target PIN in the authorization profile is used to determine whether the target PIN element belongs to the target PIN, in which the second network device is requested to be authorized to configure the parameter for the target PIN element.

In an implementation, an identifier of the second network device allowed to configure the parameter for the target PIN in the authorization profile updated by the target PIN element is used to determine whether the second network device is authorized to configure the parameter for the target PIN element; the target PIN element is the PIN element with the gateway capability, or the target PIN element is the PIN element with the management capability.

In an implementation, an identifier of the second network device allowed to configure the parameter for the PIN element with the gateway capability associated with the target PIN element in the authorization profile is used to determine whether the second network device is authorized to configure the parameter for the target PIN element; the authorization profile is updated by the PIN element with the gateway capability associated with the target PIN element, and the target PIN element is a regular PIN element.

In an implementation, the first network device is at least one of the following: a PCF; a UDR; a NEF; or a CAPIF core function.

In an implementation, the first network device is a CAPIF core function, and the method further includes: receiving a first token sent by the CAPIF core function, in which the first token is used by the NEF to authorize the second network device to configure the PIN.

In an implementation, the first network device is an NRF, and the method further includes: receiving a second token sent by the NRF, in which the second token is used by the PCF or the UDR to authorize the second network device to configure the PIN.

The device for authorizing an application function of an embodiment may send a first request to the first network device, in which the first request is used to request the first network device to authorize the second network device to configure the PIN based on the authorization profile updated by the terminal, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

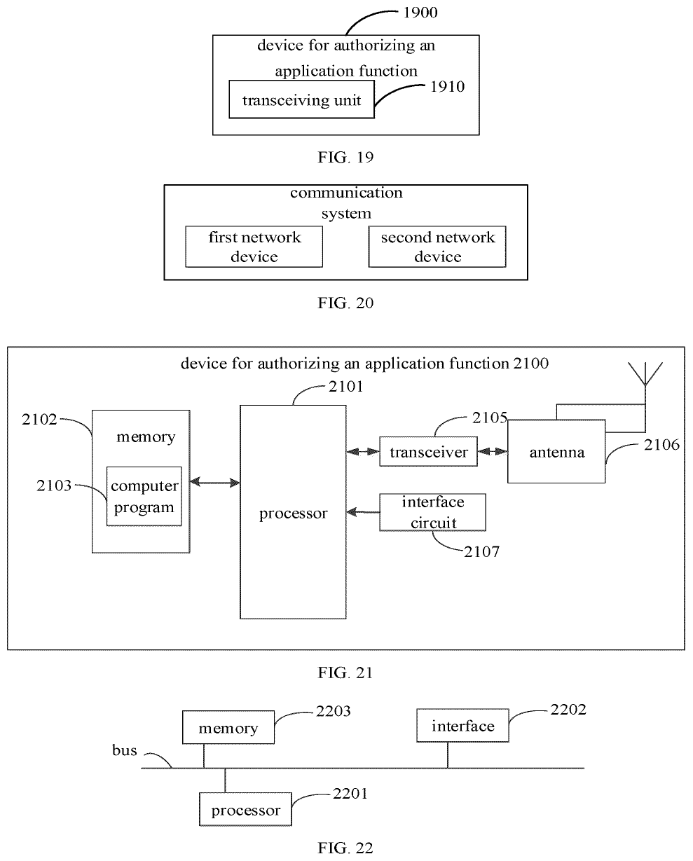

FIG. 19 is a structural diagram of a device for authorizing an application function provided in an embodiment of the present disclosure.

As shown in FIG. 19, the device for authorizing an application function 190 0 includes: a transceiving unit 1910.

The transceiving unit 1910 is configured to update an authorization profile of the terminal, in which the authorization profile is used by a first network device to determine whether to authorize a first request from the second network device, and the first request is used to request to authorize the second network device to configure a PIN.

In an implementation, the first request includes at least one of: an identifier of the second network device; an identifier of a target PIN, in which the second network device is requested to be authorized to configure the target PIN; an identifier of a PIN element with a management capability in the target PIN; an identifier of a target PIN element, in which the target PIN element is a PIN element in the target PIN, and the second network device is requested to be authorized to configure a parameter for the PIN element in the target PIN; or a first parameter used to configure the target PIN element.

In an implementation, the terminal is the PIN element with the management capability, or the terminal is a PIN element with a gateway capability.

In an implementation, the authorization profile updated by the terminal includes: an identifier of the terminal, and an identifier of the second network device allowed to configure a parameter for the terminal.

In an implementation, the terminal is the PIN element with the management capability, and the authorization profile updated by the terminal further includes: information of a PIN managed by the terminal, and an identifier of the second network device allowed to configure the PIN managed by the terminal.

In an implementation, the PIN information managed by the terminal includes at least one of: an identifier of the PIN managed by the terminal; an identifier of a PIN element with the gateway capability in the PIN managed by the terminal; an identifier of a PIN element with the management capability in the PIN managed by the terminal; an identifier of a regular PIN element in the PIN managed by the terminal; or an association relationship between the regular PIN element and the PIN element with the gateway capability in the PIN managed by the terminal.

In an implementation, the authorization profile updated by the terminal includes: an identifier of the terminal, an identifier of the second network device allowed to configure a parameter for the terminal, information of a PIN to which the terminal belongs, and an identifier of the second network device allowed to configure the PIN to which the terminal belongs.

In an implementation, the information of the PIN to which the terminal belongs includes at least one of: an identifier of the PIN to which the terminal belongs; an identifier of a PIN element with the gateway capability in the PIN to which the terminal belongs; an identifier of a PIN element with the management capability in the PIN to which the terminal belongs; an identifier of a regular PIN element in the PIN to which the terminal belongs; an association relationship between the regular PIN element and the PIN element with the gateway capability in the PIN to which the terminal belongs.

In an implementation, the transceiving unit 1910 is further configured to send the authorization profile updated by the terminal to a UDM from an access network device and an access and a mobility management capability (AMF).

In an implementation, the transceiving unit 1910 is further configured to send the authorization profile updated by the terminal to a third network device from an access network device.

The device for authorizing an application function of this embodiment may update the authorization profile of the terminal, in which the authorization profile is used by the first network device to determine whether to authorize the first request of the second network device, and the first request is used to request to authorize the second network device to configure a PIN, so that the first network device may verify whether the access of the second network device is allowed based on the authorization of the resource owner, that is, the terminal, and the access of the second network device may be limited to the level of a specific network and resource owner, thereby effectively ensuring the privacy and security of the PIN, while ensuring the security of the communication system.

FIG. 20 is a schematic diagram of a communication system provided in an embodiment of the present disclosure.

As shown in FIG. 20, the communication system includes: a first network device and a second network device.

The first network device may receive a first request sent by the second network device, and determine whether to authorize the first request based on the authorization profile, the first request is used to request the first network device to authorize the second network device to configure a PIN.

The first network device may obtain the authorization profile according to the method described in any embodiment of the present disclosure, and determine whether to authorize the first request for authorizing the second network device to configure the PIN.

Further, after authorizing the second network device to configure the PIN, the second network device may provide a parameter for configuring the PIN to the PCR/UDR.

In order to implement the above-mentioned embodiments, the present disclosure also provides a communication device, including: a processor and a memory, a computer program is stored in the memory, and the processor executes the computer program stored in the memory so that the device executes the method shown in the embodiments of FIGS. 2 to 7, or executes the method shown in the embodiments of FIGS. 8 to 12.

In order to implement the above embodiments, the present disclosure also provides a communication device, including: a processor and a memory, a computer program is stored in the memory, and the processor executes the computer program stored in the memory so that the device executes the method shown in the embodiment of FIG. 13.

In order to implement the above embodiments, the present disclosure also provides a communication device, including: a processor and an interface circuit, the interface circuit is used to receive code instructions and transmit the code instructions to the processor, the processor is used to run the code instructions to execute the method shown in the embodiments of FIGS. 2 to 7, or execute the method shown in the embodiments of FIGS. 8 to 12.

In order to implement the above embodiments, the present disclosure also provides a communication device, including: a processor and an interface circuit, the interface circuit is used to receive code instructions and transmit the code instructions to the processor, and the processor is used to run the code instructions to execute the method shown in the embodiment of FIG. 13.

FIG. 21 is a schematic diagram of the structure of another device for authorizing an application function provided in an embodiment of the present disclosure. The device for authorizing an application function 2100 may be a network device, or a terminal, or a chip, a chip system, or a processor that supports the network device to implement the above method, or a chip, a chip system, or a processor that supports the terminal to implement the above method. The device may be used to implement the method described in the above method embodiment, and the details may be referred to the description in the above method embodiment.

The device for authorizing an application function 2100 may include one or more processors 2101. The processor 2101 may be a general-purpose processor or a dedicated processor, for example, it may be a baseband processor or a central processing unit. The baseband processor may be used to process the communication protocol and communication data, and the central processing unit may be used to control the device for authorizing an application function (such as a base station, a baseband chip, a terminal, a terminal chip, a DU or a CU, etc.), execute a computer program, and process the data of the computer program.

In an implementation, the device for authorizing an application function 2100 may further include one or more memories 2102, on which a computer program 2103 may be stored, and the processor 2101 executes the computer program 2103, so that the device for authorizing an application function 2100 performs the method described in the above method embodiment. The computer program 2103 may be solidified in the processor 2101, in which case the processor 2101 may be implemented by hardware.

In an implementation, data may also be stored in the memory 2102. The device for authorizing an application function 2100 and the memory 2102 may be provided separately or integrated together.

In an implementation, the device for authorizing an application function 2100 may further include a transceiver 2105 and an antenna 2106. The transceiver 2105 may be referred to as a transceiving unit, a transceiving machine, or a transceiving circuit, etc., for implementing a transceiving function. The transceiver 2105 may include a receiver and a transmitter, the receiver may be referred to as a receiving machine or a receiving circuit, etc., for implementing a receiving function; the transmitter may be referred to as a transmitting machine or a transmitting circuit, etc., for implementing a transmitting function.

In an implementation, the device for authorizing an application function 2100 may further include one or more interface circuits 2107. The interface circuit 2107 is used to receive code instructions and transmit the code instructions to the processor 2101. The processor 2101 executes the code instructions to enable the device for authorizing an application function 2100 to execute the method described in the above method embodiment.

In one implementation, the processor 2101 may include a transceiver for implementing receiving and transmitting functions. For example, the transceiver may be a transceiving circuit, an interface, or an interface circuit. The transceiving circuit, interface, or interface circuit for implementing the receiving and transmitting functions may be separate or integrated. The above-mentioned transceiving circuit, interface, or interface circuit may be used for reading and writing code/data, or the above-mentioned transceiving circuit, interface, or interface circuit may be used for transmitting or delivering signals.

In one implementation, the device for authorizing an application function 2100 may include a circuit, and the circuit may implement the functions of sending, receiving or communicating in the method embodiment. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The device for authorizing an application function described in the above embodiments may be a network device or a terminal, but the scope of the device for authorizing an application function described in the present disclosure is not limited thereto, and the structure of the device for authorizing an application function may not be limited by FIG. 17 to FIG. 19. The device for authorizing an application function may be an independent device or may be part of a larger device. For example, the device for authorizing an application function may be:
(1) an independent integrated circuit IC, a chip, a chip system or a subsystem;
(2) a collection of one or more ICs, which, in an implementation, includes a storage component for storing data or computer programs;
(3) ASIC, such as a modem;
(4) modules that may be embedded in other devices;
(5) receivers, terminals, intelligent terminals, cellular phones, wireless devices, handheld devices, mobile units, vehicle-mounted devices, network devices, cloud devices, artificial intelligence devices, etc.;
(6) others.

In the case that the device for authorizing an application function may be a chip or a chip system, the schematic diagram of the chip structure shown in FIG. 22 may be referred. The chip shown in FIG. 22 includes a processor 2201 and an interface 2202. The number of processors 2201 may be one or more, and the number of interfaces 2202 may be multiple.

In the case that the chip is used to implement the functions of the network device in an embodiment of the present disclosure, the interface 2202 is used to transmit the code instructions to the processor, the processor 2201 is used to run code instructions to execute the method shown in FIGS. 2 to 7, or to execute the method shown in FIGS. 8 to 12.

In the case that the chip is used to implement the functions of the terminal in an embodiment of the present disclosure, the interface 2202 is used to transmit the code instructions to the processor; the processor 2201 is used to run code instructions to execute the method shown in FIG. 13.

In an implementation, the chip also includes a memory 2203, and the memory 2203 is used to store necessary computer programs and data.

A person skilled in the art may also understand that the various illustrative logical blocks and steps listed in the embodiments of the present disclosure may be implemented by electronic hardware, computer software, or a combination thereof. Whether such functions are implemented by hardware or software depends on the specific disclosure and the design requirements of the entire system. A person skilled in the art may use various methods to implement the functions described for each specific disclosure, but such implementation should not be understood as beyond the protection scope of the embodiments of the present disclosure.

An embodiment of the present disclosure also provides a communication system, the communication system includes the device for authorizing an application function as a terminal in the aforementioned embodiments of FIGS. 17 to 19, or the communication system includes the device for authorizing an application function as a terminal in the aforementioned embodiment of FIG. 21.

The present disclosure also provides a non-transitory computer-readable storage medium having instructions stored thereon, a computer execute the instructions to implement the functions of any of the above method embodiments.

The present disclosure also provides a computer program product, which implements the functions of any of the above method embodiments when executed by a computer.

In the above embodiments, it may be implemented in whole or in part by software, hardware, firmware or any combination thereof. When implemented by software, it may be implemented in whole or in part in the form of a computer program product. The computer program product includes one or more computer programs. When the computer program is loaded and executed on a computer, the process or function described in an embodiment of the present disclosure is generated in whole or in part. The computer may be a general-purpose computer, a special-purpose computer, a computer network, or other programmable device. The computer program may be stored in a non-transitory computer-readable storage medium, or transmitted from one non-transitory computer-readable storage medium to another non-transitory computer-readable storage medium. For example, the computer program may be transmitted from a website, computer, server or data center by wired (e.g., coaxial cable, optical fiber, digital subscriber line (DSL)) or wireless (e.g., infrared, wireless, microwave, etc.) mode to another website, computer, server or data center. The non-transitory computer-readable storage medium may be any available medium that may be accessed by a computer or a data storage device such as a server or data center that includes one or more available medium. The available medium may be a magnetic medium (e.g., a floppy disk, a hard disk, a magnetic tape), an optical medium (e.g., a digital video disc (DVD)), or a semiconductor medium (e.g., a solid state disk (SSD)).

A person skilled in the art may understand that the various numbers such as first and second in the present disclosure are only used for distinction and convenience of description and are not used to limit the scope of the embodiments of the present disclosure, and also indicate the order of precedence.

At least one in the present disclosure may also be described as one or more, and a plurality may be two, three, four or more, which is not limited in the present disclosure. In the embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C”and “D”.

The corresponding relationships shown in the tables in the present disclosure may be configured or predefined. The values of the information in each table are only examples and may be configured as other values, which are not limited by the present disclosure. When configuring the corresponding relationship between the information and each parameter, it is not necessarily required to configure all the corresponding relationships illustrated in each table. For example, in the table in the present disclosure, the corresponding relationships shown in some rows may not be configured. For another example, appropriate deformation adjustments may be made based on the above table, such as splitting, merging, etc. The names of the parameters shown in the titles of the above tables may also use other names that may be understood by the communication device, and the values or representations of the parameters may also be other values or representations that may be understood by the communication device. When implementing the above tables, other data structures may also be used, such as arrays, queues, containers, stacks, linear lists, pointers, linked lists, trees, graphs, structures, classes, heaps, hash tables.

The predefined in the present disclosure may be understood as defined, predefined, stored, pre-stored, pre-negotiated, pre-configured, solidified, or pre-burned.

A person skilled in the art will appreciate that the units and algorithm steps of each example described in conjunction with the embodiments may be implemented in electronic hardware, or a combination of computer software and electronic hardware. Whether these functions are performed in hardware or software depends on the specific application and design constraints of the technical solution. Professional and technical personnel may use different methods to implement the described functions for each specific application, but such implementation should not be considered to be beyond the scope of this disclosure.

A person skilled in the art may clearly understand that, for the convenience and brevity of description, the specific working processes of the systems, devices and units described above may refer to the corresponding processes in the aforementioned method embodiments and will not be repeated here.

It should be understood that the various forms of processes shown above may be used to reorder, add or delete steps. For example, the steps recorded in the embodiments of the present disclosure may be executed in parallel, sequentially or in different orders, as long as the desired results of the technical solution of the present disclosure may be achieved, and the present disclosure does not limit it.

The above specific implementations do not constitute a limitation on the protection scope of the present invention. It should be understood by a person skilled in the art that various modifications, combinations, sub-combinations and substitutions may be made according to design requirements and other factors. Any modification, equivalent substitution and improvement made within the spirit and principle of the present disclosure should be included in the protection scope of the present disclosure.

1. A method for authorizing an application function, performed by a first network device, comprising:
receiving a first request sent by a second network device, wherein the first request is used to request to authorize the second network device to configure a personal internet of things network (PIN);
obtaining an authorization profile updated by a terminal;
determining whether to authorize the first request based on the authorization profile.

2. The method according to claim 1, wherein the first request comprises at least one of:
an identifier of the second network device;
an identifier of a target PIN, wherein the second network device is requested to be authorized to configure the target PIN;
an identifier of a PIN element with a management capability in the target PIN;
an identifier of a target PIN element, wherein the target PIN element is a PIN element in the target PIN, and the second network device is requested to be authorized to configure a parameter for the PIN element in the target PIN; or
a first parameter used to configure the target PIN element.

3. The method according to claim 2, wherein the terminal is the PIN element with the management capability, or the terminal is a PIN element with a gateway capability.

4. The method according to claim 3, wherein the authorization profile updated by the terminal comprises:
an identifier of the terminal, and first identifier of the second network device allowed to configure a parameter for the terminal.

5. The method according to claim 4, wherein the terminal is the PIN element with the management capability, and the authorization profile updated by the terminal further comprises:
information of a PIN managed by the terminal, and a second identifier of the second network device allowed to configure the PIN managed by the terminal.

6. The method according to claim 5, wherein the information of the PIN managed by the terminal comprises at least one of:
an identifier of the PIN managed by the terminal;
an identifier of a PIN element with the gateway capability in the PIN managed by the terminal;
an identifier of a PIN element with the management capability in the PIN managed by the terminal;
an identifier of a regular PIN element in the PIN managed by the terminal; or
an association relationship between the regular PIN element and the PIN element with the gateway capability in the PIN managed by the terminal.

7. The method according to claim 3, wherein the authorization profile updated by the terminal comprises:
an identifier of the terminal, a first identifier of the second network device allowed to configure a parameter for the terminal, information of a PIN to which the terminal belongs, and a third identifier of the second network device allowed to configure the PIN to which the terminal belongs.

8. The method according to claim 7, wherein the information of the PIN to which the terminal belongs comprises at least one of:
an identifier of the PIN to which the terminal belongs;
an identifier of a PIN element with the gateway capability in the PIN to which the terminal belongs;
an identifier of a PIN element with the management capability in the PIN to which the terminal belongs;
an identifier of a regular PIN element in the PIN to which the terminal belongs;
an association relationship between the regular PIN element and the PIN element with the gateway capability in the PIN to which the terminal belongs.

9. The method according to claim 3, further comprising:
determining that the first request satisfies each of at least one preset condition, and authorizing the first request;
determining that the first request does not satisfy any one of the at least one preset condition, and rejecting the first request;
wherein the at least one preset condition comprises: determining that the second network device is authorized to configure the target PIN based on a fourth identifier of the second network device allowed to configure the target PIN in the authorization profile.

10. The method according to claim 9, wherein the at least one preset condition further comprises:
determining that the target PIN element belongs to the target PIN based on the information of the target PIN in the authorization profile, wherein the second network device is requested to configure the parameter for the target PIN element.

11. The method according to claim 10, wherein the at least one preset condition further comprises:
determining that the second network device is authorized to configure the parameter for the target PIN element based on a fifth identifier of the second network device allowed to configure the parameter for the target PIN element in the authorization profile updated by the target PIN element;
wherein the target PIN element is the PIN element with the gateway capability, or the target PIN element is the PIN element with the management capability; or
determining that the second network device is authorized to configure the parameter for the target PIN element based on a sixth identifier of the second network device allowed to configure the parameter for the PIN element with the gateway capability associated with the target PIN element in the authorization profile;
wherein the authorization profile is updated by the PIN element with the gateway capability associated with the target PIN element, and the target PIN element is a regular PIN element.

12. (canceled)

13. The method according to claim 1, wherein obtaining the authorization profile updated by the terminal comprises:
receiving a notification sent by a unified data management (UDM), wherein the notification comprises the authorization profile updated by the terminal; or
sending a second request to a third network device, wherein the second request is used to request the authorization profile updated by the terminal, and the second request comprises an identifier of the terminal; and receiving the authorization profile updated by the terminal and sent by the third network device.

14. (canceled)

15. The method according to claim 1, wherein the first network device is at least one of:
a policy control function (PCF);
a unified data repository (UDR);
a network exposure function (NEF); or
a common application programming interface framework (CAPIF) core function.

16. The method according to claim 1, wherein the first network device is an NEF, and the method further comprises:
sending the first request to a PCF or UDR; or
wherein the first network device is a CAPIF core function, it is determined that the second network device is authorized to configure the PIN, and the method further comprises:
generating a first token, wherein the first token is used by an NEF to authorize the second network device to configure the PIN; and sending the first token to the second network device; or
wherein the first network device is a network repository function (NRF), it is determined that the second network device is authorized to configure the PIN, and the method further comprises:
generating a second token, wherein the second token is used by a PCF or a UDR to authorize the second network device to configure the PIN; and sending the second token to the second network device.

17-18. (canceled)

19. A method for authorizing an application function, performed by a second network device, comprising:
sending a first request to a first network device, wherein the first request is used to request the first network device to authorize the second network device to configure a personal internet of things network (PIN) based on an authorization profile updated by a terminal.

20-31. (canceled)

32. The method according to claim 19, wherein the first network device is a common application programming interface framework (CAPIF) core function, and the method further comprises:
receiving a first token sent by the CAPIF core function, wherein the first token is used by a network exposure function (NEF) to authorize the second network device to configure the PIN; or
wherein the first network device is a network repository function (NRF), and the method further comprises:
receiving a second token sent by the NRF, wherein the second token is used by a policy control function (PCF) or a unified data repository (UDR) to authorize the second network device to configure the PIN.

33. (canceled)

34. A method for authorizing an application function, performed by a terminal, comprising:
updating an authorization profile of the terminal, wherein the authorization profile is used by a first network device to determine whether to authorize a first request from a second network device, and the first request is used to request to authorize the second network device to configure a personal internet of things network (PIN).

35-41. (canceled)

42. The method according to claim 34, further comprising:
sending the authorization profile updated by the terminal to a unified data management (UDM) from an access network device and an access and a mobility management capability (AMF); or
sending the authorization profile updated by the terminal to a third network device from an access network device.

43. (canceled)

44. A first network device, comprising:
a processor, and a memory for storing a computer program executable by the processor,
wherein the processor is configured to perform the method according to claim 1.

45. A second network device, comprising:
a processor, and a memory for storing a computer program executable by the processor,
wherein the processor is configured to perform the method according to claim 19.

46-47. (canceled)
